(19) United States
(12) Patent Application Publication
(10) Pub. No.: US 2025/0127072 A1
(43) Pub. Date: Apr. 24, 2025

(54) CROP DETECTION SYSTEM AND/OR METHOD THEREFORE

(71) Applicant: FarmWise Labs, Inc., Santa Clara, CA (US)

(72) Inventors: Arnaud Delaunay, Santa Clara, CA (US); Grégoire Lothe, Santa Clara, CA (US)

(73) Assignee: FarmWise Labs, Inc., Santa Clara, CA (US)

(21) Appl. No.: 18/921,831

(22) Filed: Oct. 21, 2024

Related U.S. Application Data
(60) Provisional application No. 63/592,046, filed on Oct. 20, 2023.
(60) Provisional application No. 63/676,813, filed on Jul. 29, 2024.

(51) Int. Cl. A01B 79/00

(52) U.S. Cl. CPC A01B 79/005

(57) ABSTRACT

The system can include a detection model; an optional camera system; and an optional control system. The system can function to detect plants within a field. Additionally, the system can function to facilitate an agriculture operation(s) based on the positions of plants within the field. Variants of the system can be configured to (autonomously) perform and/or facilitate agriculture operations which can include: agent dispersal (e.g., solid agent dispersal), fluid spraying, crop imaging (e.g., crop data collection), side dressing, weeding (e.g., mechanical actuation, targeted laser ablation, etc.), harvesting, planting, tilling, fertilizing, irrigating, and/or any other suitable operation(s). Variants of the system and/or method can be used to facilitate detection and/or agriculture operations for single crops, multi-crops (e.g., crop doubles, where agriculture operations may be based on stem proximity), ground cover plants, weeds, and/or agriculture operations in any other suitable scenarios.

### CROSS-REFERENCE TO RELATED APPLICATIONS

This application claims the benefit of U.S. Provisional Application No. 63/592,046 filed 20 Oct. 2023 and U.S. Provisional Application No. 63/676,813 filed 29 Jul. 2024, each of which is incorporated in its entirety by this reference.

### TECHNICAL FIELD

This invention relates generally to the agriculture automation field, and more specifically to a new and useful plant detection system and/or method in the agriculture automation field.

### BRIEF DESCRIPTION OF THE FIGURES

FIG. 1 is a schematic representation of a variant of the system.

FIG. 2 is a schematic representation of a variant of the system.

FIG. 3 is a schematic representation of a variant of the method.

FIGS. 4A-4C are schematic representations of variants of detecting plants, aggregating plant characteristics, and determining a plant characteristic uncertainty.

FIG. 5 is a schematic representation of a variant of tracking detection results.

FIG. 6 is a schematic representation of a variant of detecting plants.

FIG. 7 is a schematic representation of a variant of detecting plants.

FIG. 8 is a representation of a variant of the agricultural implement.

FIG. 9 is a schematic representation of a variant of determining a detection result tracking set.

FIG. 10 is an example of detection results for a field image in a variant of the method.

FIG. 11 is a set of example crop images for the brassica family of plants, illustrating the lack of visual coherence in crop taxonomy.

FIG. 12 is a variant of an example image of a celery field with a volunteer crop.

FIG. 13 is an illustrative example of a variant of different task models.

FIG. 14 is an illustrative example of a variant of determining a plant component location map.

FIGS. 15A-15C are schematic representations of variants of the detection model.

FIG. 16 is an illustrative example of a variant of the detection model.

FIGS. 17A-17B are representations of variants of a field image and a detection result, respectively.

FIG. 18 is a flowchart diagram of a variant of matching detection results from different field images.

FIG. 19 is a flowchart diagram of a variant of generating an implied detection result.

FIG. 20 is a representation of a variant of an uncertainty region.

FIG. 21 is a flowchart diagram of a variant of determining a set of detection results.

FIG. 22 is a flowchart diagram of an example of the method.

FIG. 23 is a schematic representation of a variant of the system.

FIGS. 24A-24C are schematic representations of variants of determining an instance map.

### DETAILED DESCRIPTION

The following description of the embodiments of the invention is not intended to limit the invention to these embodiments, but rather to enable any person skilled in the art to make and use this invention.

### 1. Overview

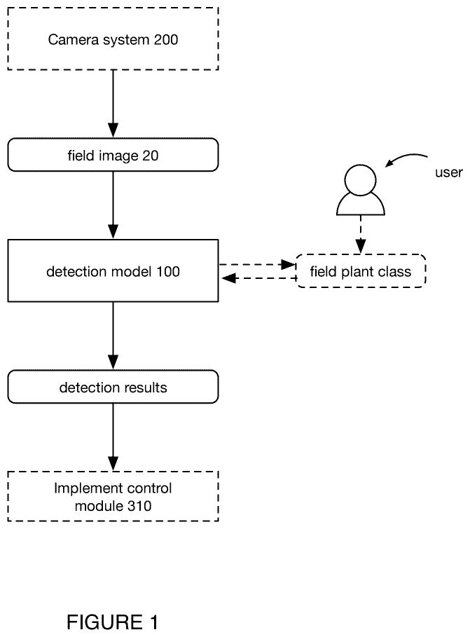

The system, an example of which is shown in FIG. 1, can include an optional camera system 200; a detection model 100 running on a control system 300; an agricultural implement 400, and/or any other suitable components. The system can function to detect plants within a field. Additionally, the system can function to facilitate an agriculture operation(s) based on the locations of plants within the field.

The detection model 100 can include: a backbone 110, a classification model 130, a plurality of task models 120, and a selector 140. However, the detection model 100 can additionally or alternatively include any other suitable set of components. The detection model 100 functions to detect and/or localize plants within a field.

In variants, the term plant ‘class’ and/or ‘classification’ may be utilized herein in reference to a specific biological taxon, an appearance-based grouping, and/or a task model index as appropriate. For example, ‘class’ and/or ‘classification’; can refer to a plant class, a crop taxon, and/or any other suitable subset of types of plants. Thus, classes may be defined by biological taxon, task model indices, ‘appearance-based’ groupings of plants, and/or can be otherwise suitably defined/referenced. However, the terms ‘class’ and/or ‘classification’ may be otherwise suitably referenced.

The term “substantially” as utilized herein can mean: exactly, approximately, within a predetermined threshold or tolerance, and/or have any other suitable meaning.

The term “agricultural implement” as utilized herein, in the context of agricultural machinery, weeding systems, or otherwise, can refer to a farm implement, agriculture implement, and/or other suitable implement(s), and these terms—along with at least: “tool,” “actuator,” and “equipment,”—may be interchangeably referenced herein. For example, the agricultural implement 400 may be a pushed and/or pulled by a vehicle (e.g., a tractor) to facilitate one or more agricultural operations (e.g., weeding, crop data collection, pesticide/herbicide spraying, harvesting, etc.), and/or can be otherwise operated. However, it is understood that the modular (implement) assembly may be likewise configured to perform various agricultural operations (e.g., weeding, crop data collection, pesticide/herbicide spraying, harvesting, etc.), data collection/processing, and/or may operate in conjunction with various effectors and/or without an effector (e.g., to perform crop data collection).

### 1.1 Illustrative Examples

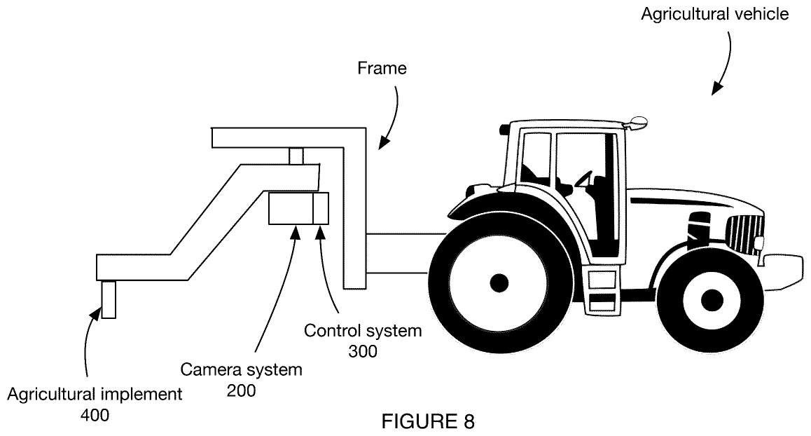

In one set of variants, a camera system 200 (e.g., onboard an agricultural implement 400; example shown in FIG. 8) can periodically capture field images 20 to facilitate plant detection (e.g., single shot) and localization (e.g., in substantially real time) by a detection model 100 running on a control system 200. Plant detection can be performed with a single model backbone, which extracts field image features (e.g., an embedding map 45) which are processed, in parallel, by a plurality of task models 120 (e.g., acting as model heads).

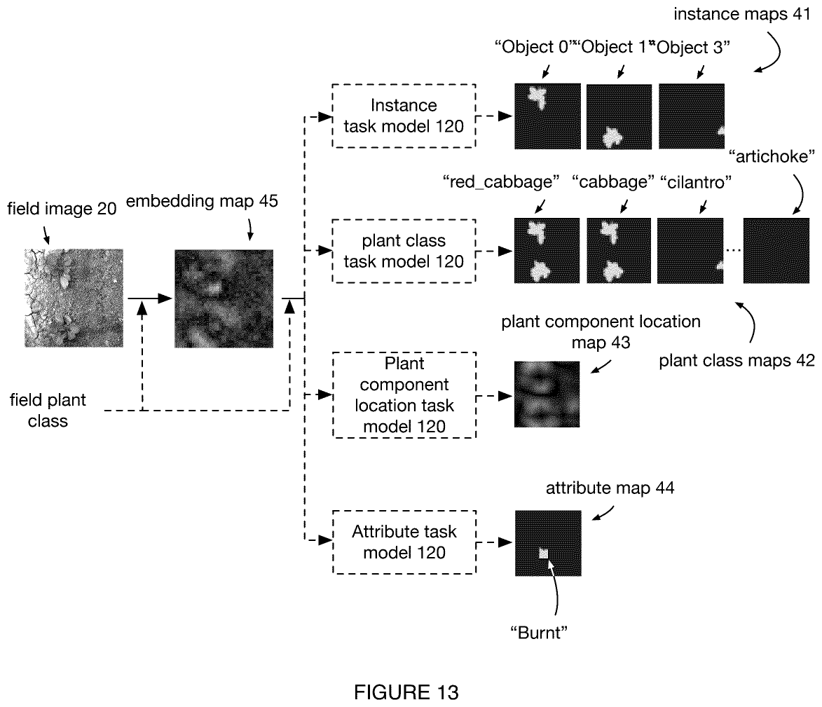

In a first variant, the field image 20 can be processed by a set of parallel task models 120, each trained to perform a different type of output map (e.g., a multidimensional tensor, etc.; example shown in FIG. 13). Examples of task models 120 include task models 120 which generate an instance segmentation map 41 which segments the field image features by instance, a plant class map 42 which segments the field image features by plant class, a plant component location map 43 which includes an array of vectors indicating an estimate of the nearest plant stem position, an attribute map 44 which represents attributes of plants (e.g., age, health, harvestability, etc.) and/or any other suitable type of map. In an example of this variant, a task model 120 determines an attribute map 44 representing crop health parameters based on the embedding map, and in S400, control instructions are determined based on the determined attribute map 44 representing crop health parameters to selectively treat parts of the row with a crop health parameter indicating a value within a predetermined range (e.g., spraying plants with a threshold number of indicators of an infection, etc.).

In a second variant, the field image 20 can be processed by a set of task models 120 each acting as a plant detector head. The plant detector heads, each associated with a specific class, can determine a boundary box for the respective plant class, and stem position (e.g., meristem location, stem-ground intersection position, etc.), and can additionally determine a binary classification (for a specific class), confidence and/or uncertainty scores for the predictions (e.g., for the detection result, for the stem position, etc.), an IoU prediction, and/or other predictions. The classification model determines a multi-class classification, which can be used to select a single task model 120 for the field image 20 as a whole. For instance, the classification model can determine a score for each plant detector head class and/or a multi-class classification for the field image 20 as a whole.

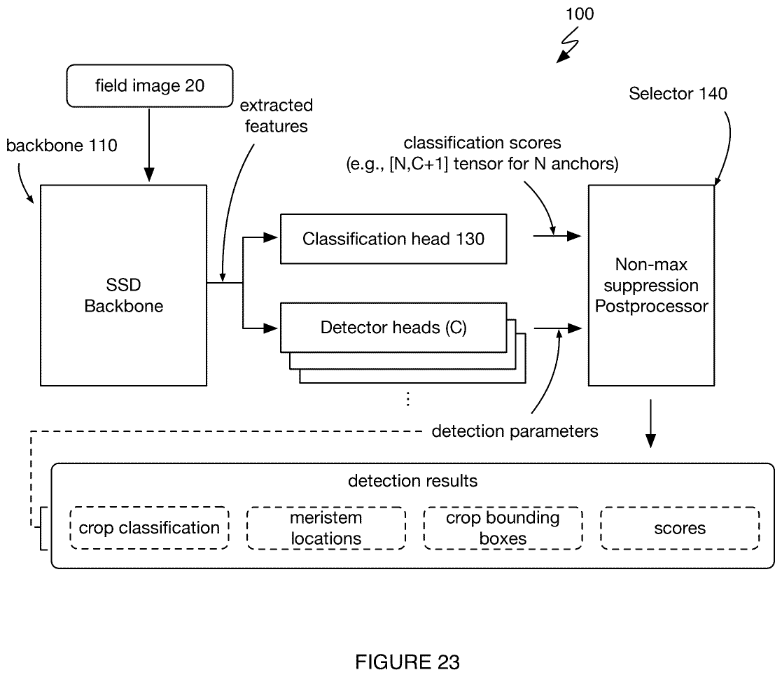

In a set of variants, the outputs of the task models 120 are post-processed at a selector to yield a set of detection results, such as via a non-max suppression algorithm based on the multi-class classifications by the classification model (e.g., example shown in FIG. 23) and/or by aggregating pixelwise predictions of plant class and stem position (e.g., by instance from maps generated in the second variant). The detections can then be used to localize the individual plants by transforming the estimated stem locations of a primary plants (e.g., crops) of the field (e.g., neglecting weeds, volunteer crops, etc.), in the field image frame, into Earth coordinates (e.g., GPS position) and/or effector coordinates (e.g., of an autonomous agricultural implement 400) to facilitate agriculture operation via a control system. In examples, plant information (e.g., bounding box, meristem position, plant health parameters, etc.) can be determined (e.g., trilaterated from predictions from multiple field images 20 of the same plant), tracked, predicted, and/or otherwise managed in 3D (e.g., instead of 2D, etc.).

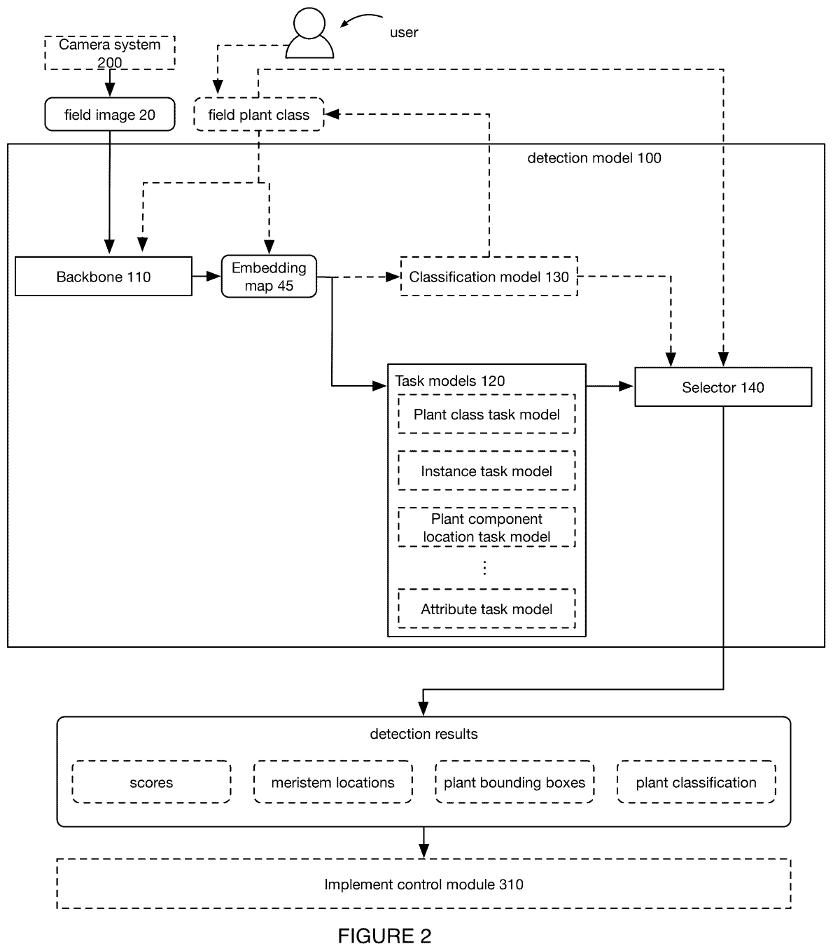

Variations can be used with or without a Human Machine Interface [HMI] to facilitate automatic and/or semi-automatic classification via the multi-head detection model 100. For example, variants can facilitate fully-automatic operations (e.g., without manual input at the HMI) and/or semi-automatic operations (e.g., receiving a user input of a current field plant class; example shown in FIG. 2) prompting user at an HMI based on automatic detections/classifications of plants). Additionally or alternatively, variants can provide feedback (e.g., via an HMI) based on results generated with the multi-head detection model 100 to facilitate various autonomous, semi-autonomous, and/or manual operations.

### 2. Benefits

Variations of the technology can afford several benefits and/or advantages.

First, variants of this technology can operate with both sparse crop rows (e.g., rows containing discrete, countable plants) and/or dense crop rows (e.g., rows containing bushy, overlapping plants). When the system is treating a sparse row, an instance map 41 can be used to facilitate row treatment (e.g., determining stem positions per-instance, determining plant classes per-instance, etc.). When the system is treating a dense row, a plant class map 42 can be used facilitate row treatment (e.g., treating the boundary of the desired plant class, etc.). Due to the parallel nature of the task heads, the system can operate on both sparse and dense crop rows within the same operation cycle without substantially changing field image processing methodologies (e.g., by alternating between instance-based treatment, stem-based treatment, plant class-based treatment, plant attribute-based treatment, etc.; using a unitary model and/or operational process).

Second, variants can utilize task models which are plant class-agnostic (i.e., task models do not need to be retrained when a new plant class or new plant sub-class is added to an operation domain). Additionally, the usage of a single or small number of plant class-agnostic task models enables the detection model to be small yet robust (e.g., trained on plant of many different classes); as opposed to a task model with a high number of plant class-specific task models. Furthermore, class-agnosticism can allow the detection model to work on plant classes not represented in training data (e.g., most tasks are not plant class-specific) and can work with or without a field plant class prior, enabling the system to be robust to different treatment circumstances and levels of information.

Third, variants can leverage an assumption of primary plant class uniformity within a field to improve detection/classification accuracy for individual plants. For example, the detection model 100 can be configured to determine a single object/plant classification for an input field image 20 and/or detect a single plant class, even where multiple classes of plants may be present (e.g., volunteer crops, weeds, ground cover crops, etc.; an example is shown in FIG. 12; aligning the model with the conditional nature of a decision to keep or remove plants). Such variants may naturally filter out non-targeted plant varietals, such as weeds or volunteer crops, from detection and subsequent treatment via an agricultural operation(s). For instance, variants can facilitate weeding or chemical treatment around a primary plant varietal (i.e., the cultivated crop of the field) and eliminate non-targeted plant varietals (e.g., weeds). In variants where the detection model is configured to determine multiple plant classifications, field plant class can be used as an optional prior for the backbone, which can enable the method to run both on fields of a known plant class and fields of an unknown plant class.

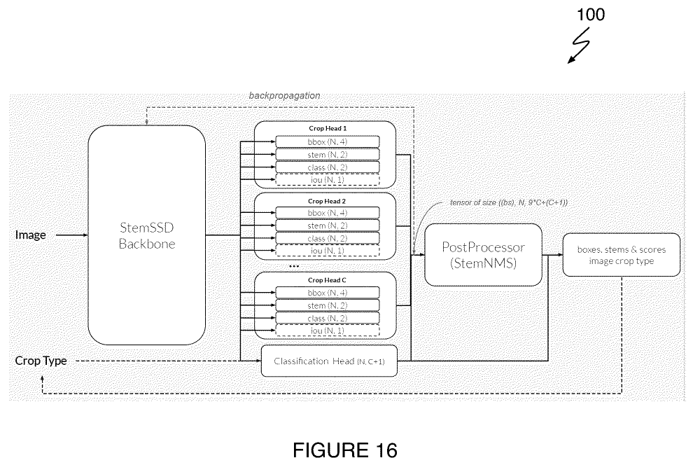

Fourth, variants can facilitate knowledge sharing between fields and/or plant class (e.g., decisions can be made based on the model trained with the most closely related training data; the backbone can be trained by backpropagation of data from multiple heads and plant class, an example of which is illustrated in FIG. 16). For instance, plants may not be visually coherent even within the same taxonomy group (e.g., brassica genus; biological taxon; an example of which is illustrated in FIG. 11), so it may be advantageous to incorporate knowledge across various fields, plant classes, and/or operational contexts to improve detection accuracy and avoid the need to deploy dedicated models for individual detection environments. Additionally, many distinct plant class may appear substantially similar (e.g., at various growth stages) and thus may be classified coherently by a single plant detector head, irrespective of the differences in plant taxonomy. The plant detector head ‘classes’ may thus provide greater coherence for the purposes of visual identification accuracy and localization than biological taxon. Additionally, variants may avoid the need to identify the most appropriate model for a particular detection scenario (e.g., manually by an operator or otherwise, such by an input at a human machine interface [HMI]), since the model may naturally accommodate various plant classes/environments (e.g., weeding scenarios; identification surrounding ground cover plants; detection/segmentation of single plants, plant doubles, etc.). For example, variants can facilitate automatic switching between applicable models based on knowledge of field (e.g., prior detections, historical data received at an HMI, based on geo-location, etc.). Additionally, some tasks are not plant class-specific (e.g., stem localization, instance identification, burn region identification, etc.) and can be performed by the same task model for fields with plants of different classes.

Fifth, variants can facilitate ‘partial’ updates to individual task models, since task models heads may be added, updated, and/or retrained independently of the remainder of task models heads (e.g., avoiding the need to fully retrain the model and/or extant task models heads and thereby reducing the required training time/complexity; new task models may be added by fine tuning an existing task model for a similar plant class, for example), which may reduce the training time and maintenance requirements for individual task models and the detection model 100 as a whole.

Sixth, variants may facilitate detection of visually distinct plants within a taxonomy grouping (e.g., genus, species, etc.) via multiple, distinct task models. Additionally, separate task models may be trained to classify the same plant species at different stages of growth (e.g., a first task model may be trained to classify the plant at 3 weeks; a second task model may be trained to classify the plant at 6 weeks; for each weeding cycle of a particular plant class).

Seventh, variants can perform classification and/or localization within a single field image 20 via a single shot detector (SSD) (e.g., in substantially real time). Additionally, variants can utilize a prior classification(s) of the plant class to improve cyclic performance, where field images 20 captured within a recent time history may inform the classification under an assumption of plant class uniformity within a field (e.g., which may be particularly advantageous if a volunteer crop[s] appear in a current field image frame). Moreover, the usage of parallel task models enables faster plant detection than task models in series (e.g., determining a set of instances, then determining a label for each instance; etc.).

Eighth, variants of the technology can determine a more accurate plant component locations for each individual plant based on plant component location information determined from different field images 20. For example, variants of the technology can track stem positions in world coordinates (e.g., 3D), which can remove errors due to planar ground, perpendicular FOV, parallel travel, and other simplifying assumptions. Additionally, a stem position uncertainty for each stem can be determined by combining the stem prediction confidence scores across multiple field images 20, which can enable a treatment implement to be dynamically controlled based on the combined confidence score. For example, a treatment buffer zone size can be inversely related to the stem prediction confidence (e.g., smaller buffer zone for higher confidence stem position predictions; larger buffer zone for lower confidence stem position predictions, etc.). This can enable plants to be treated (e.g., weeded, fertilized, etc.) with higher efficacy, since treatments can be applied much closer to high-confidence stem position predictions, which can remove weeds and other plants crowding the plant of interest, while maintaining a treatment buffer zone for lower-confidence stem position predictions.

Additionally, variations of this technology can include an approach necessarily rooted in computer technology for overcoming a problem(s) specifically arising in the realm of autonomous systems, such as environmental awareness for autonomous planning/control, object detection/classification, and/or other computer technology challenges. In a first example, the technology can automatically detect crops (e.g., on a per-row basis) and autonomously control implement effectors to perform an agriculture operation (e.g., weeding) based on the detection results (e.g., crop detections). In a second example, the technology can enable control of a partially and/or fully autonomous system via edge sensing, compute, and actuation/control. In a third example, the technology can facilitate agriculture operations via remote (tele-) operation of the system and/or elements thereof. In a fourth example, variants can facilitate autonomous field data generation during an agriculture operation, with plant-level localization, which may facilitate plant-level analysis (e.g., individual plants and/or field aggregates; yield estimation based field image analysis of individual plant detections, etc.). In a fifth example, the system can facilitate operation in conjunction with a manned or unmanned vehicle (e.g., tractor), with remote operation (i.e., tele-operation) of system parameters via an HMI.

However, variations of the technology can additionally or alternately provide any other suitable benefits and/or advantages.

### 3. System

The system, an example of which is shown in FIG. 1, can include a detection model 100; an optional camera system 200; and an optional control system 300. The system can function to detect plants within a field. Additionally, the system can function to facilitate an agriculture operation(s) based on the positions of plants within the field. Variants of the system can be configured to (autonomously) perform and/or facilitate agriculture operations which can include: agent dispersal (e.g., solid agent dispersal), fluid spraying, crop imaging (e.g., crop data collection), side dressing, weeding (e.g., mechanical actuation, targeted laser ablation, etc.), harvesting, planting, tilling, fertilizing, irrigating, and/or any other suitable operation(s).

Variants of the system and/or method can be used to facilitate detection and/or agriculture operations for single crops, multi-crops (e.g., crop doubles, where agriculture operations may be based on stem proximity), dense crop lines/rows, ground cover plants, weeds, and/or agriculture operations in any other suitable scenarios.

In variants, all or portions of the system can be implemented by a controller of an agricultural system (e.g., such as that disclosed in U.S. application Ser. No. 18/435,924 filed Feb. 7, 2024, incorporated herein in its entirety by this reference), the controller of a sensing module acting as a control system 300 (e.g., such as that disclosed in U.S. application Ser. No. 18/435,730 filed Feb. 7, 2024, incorporated herein in its entirety by this reference), by a cloud computing system, and/or by any other suitable computing system.

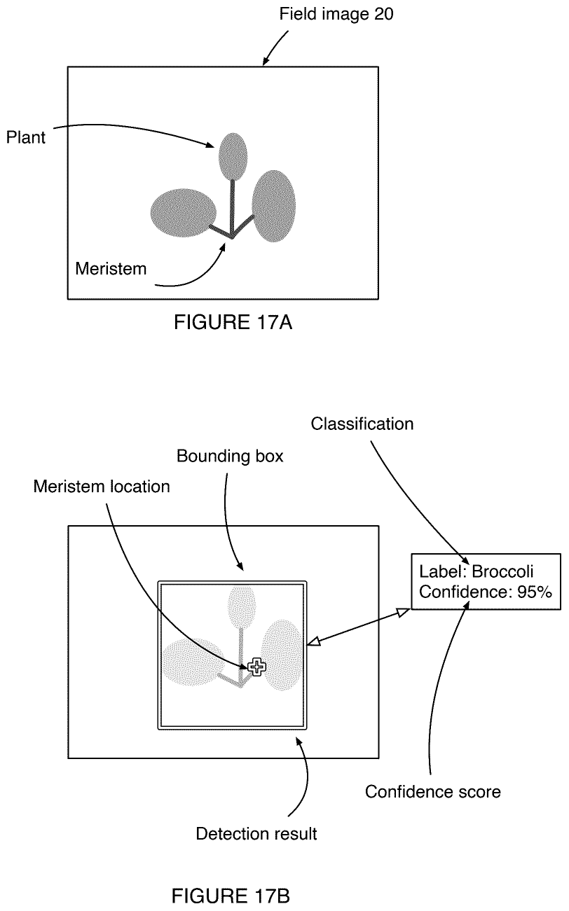

The optional camera system 200 functions to capture (e.g., S210) field images 20 (e.g., example shown in FIG. 17A) to facilitate plant detection via the multi-head detection model 100. For example, the camera system can include a single sensor (e.g., cameras) and/or a plurality of sensors (e.g., arrayed and/or not arrayed). Examples of camera types include visible light cameras, IR cameras, multispectral cameras, thermal cameras, and/or cameras detecting any other suitable type of information.

The sensors are preferably calibrated within a predetermined pose and/or coordinate frame (e.g., where the pose of camera sensors is substantially maintained relative to the ground by dynamic control of an implement/actuator) and/or can be substantially maintained in a fixed/predetermined arrangement relative to the surface of the bed (e.g., fixed position relative to a target plane, such as a ground plane). Alternatively, field images 20 can be pre-processed and/or post-processed to adjust for changes in the height and/or angle of the cameras relative to the bed, such as by bundle adjustment (e.g., minimizing the reprojection error between the pixel locations of observed and predicted field image points), homography, and/or other suitable field image processing and/or pose estimation techniques. In variants, the camera system can include a depth estimation system (e.g., estimating the distance between the camera and the features depicted by a set of camera pixels) an odometry system, and/or other auxiliary sensing modalities. The depth estimation system can include a feeler wheel, stereo camera (e.g., including the cameras of the camera system; be a separate stereo camera set, etc.), monocular depth estimation model, and/or any other suitable depth estimation system. The odometry system can be used to estimate the change in pose of the camera (e.g., a “delta pose”) between captured field images 20 in order to determine plant locations, plant component locations, image region locations, etc. (e.g., via extrapolation, interpolation, triangulation, etc.). The odometry system can use the captured field images 20, depth information, motion and/or location data (e.g., from IMUs, GPSs, wheel encoders, accelerometers, etc.), and/or any other suitable data to estimate the camera pose change (e.g., step S220). The odometry system can use visual odometry, visual-inertial odometry, dead reckoning, feature tracking, optical flow, RF-based localization, encoder data (e.g., from a wheel encoder), and/or any other suitable method to determine the camera pose change. However, the odometry system can be otherwise configured. However, the system can include or operate in conjunction with any other suitable camera system, and/or receive field images 20 from any other suitable endpoints.

The system can be configured to process field image frames in substantially real time relative, such as via single shot detection, to facilitate real time localization of plants. However, the system can process field images 20 with any suitable timing/frequency, and/or can operate without a camera system (e.g., process field images 20 from an external/remote camera).

The system can optionally include and/or operate in conjunction with a control system 300, such as a control system of an autonomous or semi-autonomous agricultural implement 400. Processing for the detection model 100 preferably occurs locally (e.g., at the control system 300 and/or a centralized processor thereof) but can occur at least partially remotely (e.g., cloud computing/processing) and/or can be otherwise performed. Processing for the control system and/or multi-head detection model 100 can be centralized, distributed, decentralized (e.g., edge compute) and/or otherwise suitably implemented. In an example, the camera system 200, model compute (i.e., computing system storing and/or executing the multi-head detection model 100), and/or control system 300 can be packaged within a single housing/module (e.g., edge compute) of an agricultural implement 400. In a first set of variants, the control system can be the “controller 240” described in U.S. application Ser. No. 18/435,924 filed Feb. 7, 2024, incorporated herein in its entirety by this reference. In a second set of variants, the control system can be the “computing system” described in U.S. application Ser. No. 18/435,730 filed Feb. 7, 2024, incorporated herein in its entirety by this reference.

However, the system can include any other suitable control system(s), onboard an agricultural implement 400 or otherwise, and/or can be otherwise suitably implemented.

The detection model 100 (equivalently referred to herein as: “multi-head detection model,” “multi-head model,” etc.) can include: a backbone 110, a classification model 130, a plurality of task models 120 (e.g., output heads of the detection model), and a selector. In variants, the plurality of task models can optionally include a set of stem detectors (e.g., stem keypoint detectors). However, the detection model 100 can additionally or alternatively include any other suitable set of components. The detection model 100 functions to detect and/or localize plants within a field (e.g., to perform S230; example shown in FIG. 17B).

The detection model 100 is preferably a panoptic model (e.g., which unifies semantic segmentation and instance segmentation, etc.); however, the detection model can be otherwise structured. The detection model 100 and/or subelements thereof (e.g., the backbone 110, classification model 130, task models 120, and/or selector 140) can include machine learning-based or non-machine learning-based architectures. The components of the detection model 100 can include: a binary classifier, a multi-class classifier, a neural network model(s) (e.g., DNN, CNN, RNN, etc.), a logistic regression model, Bayesian networks (e.g., naïve Bayes model), a cascade of neural networks, compositional networks, ensemble networks, Markov chains, decision trees, predetermined rules, probability distributions, heuristics, probabilistic graphical models, and/or other models. The detection model 100 and/or components thereof can perform or not perform dimensionality reduction (e.g., using an autoencoder, convolutions, principal component analysis, max pooling, t-SNE, etc.) at any suitable part of the detection model. In an example, the output of the backbone is an embedding map 45 of a field image 20 input into the backbone, wherein the embedding map 45 can have a lower dimensionality than the field image 20 (e.g., with a height which is a fraction of the image height and a width which is a fraction of the image width; for example, a height of H/8 and a width of W/8, etc.). The embedding map 45 can be translation-invariant, translation-equivariant, and/or can otherwise be affected by translation (e.g., in pixel space and/or in world space, etc.).

The output of the detection model 100 can be a set of maps, a plant class, and/or a set of detection results, which can each include plant component locations and/or orientations, plant bounding boxes, plant stem shapes, plant classification, uncertainties and/or confidences associated with any of the aforementioned attributes, and/or any other suitable plant attribute. Examples of plant components that can be detected can include: meristems, stems, leaves, flowers, canopies, nodes, blades, stolons, crowns, and/or any other suitable plant component.

### 3.1 Backbone

The detection model 100 can include a backbone 110 (e.g., a first set of neural network layers), which functions to extract features (e.g., an embedding map 45) which can be used to facilitate subsequent detection/classification via the task models. The backbone 110 receives a field image 20 (e.g., RGB image from a camera system) and outputs a set of extracted features to the task model(s) of the detection model 100 (i.e., for prediction/inference).

More preferably, the backbone 110 is an SSD backbone (e.g., pretrained neural network backbone, such as ResNet, YOLO, etc.; trained on ImageNet; an example is shown in FIG. 12), which is pretrained on a generalized set of images (e.g., open-source model trained on a variety of object detection scenarios; tuned for various field contexts, etc.). However, the backbone can be a neural network model (e.g., CNN, FCN, etc.), a transformer-based model (e.g., VIT), YOLO model, SSD model (e.g., pre-built), and/or any other suitable feature-extraction model(s). The backbone 110 is preferably an encoder but can alternatively have any other suitable architecture.

The backbone is preferably shared (jointly) by each of the task models (i.e., provides the same set of inputs to each task model; fully connected to each task model) but can additionally or alternatively be partially connected to the task models and/or connected to the task models with any other suitable relationship and/or arrangement. Additionally or alternatively, one or more task models can be connected to the backbone 110 distinct, individual arrangements and/or can receive any other suitable data as inputs (e.g., a prior classification[s] of the plant class within a field).

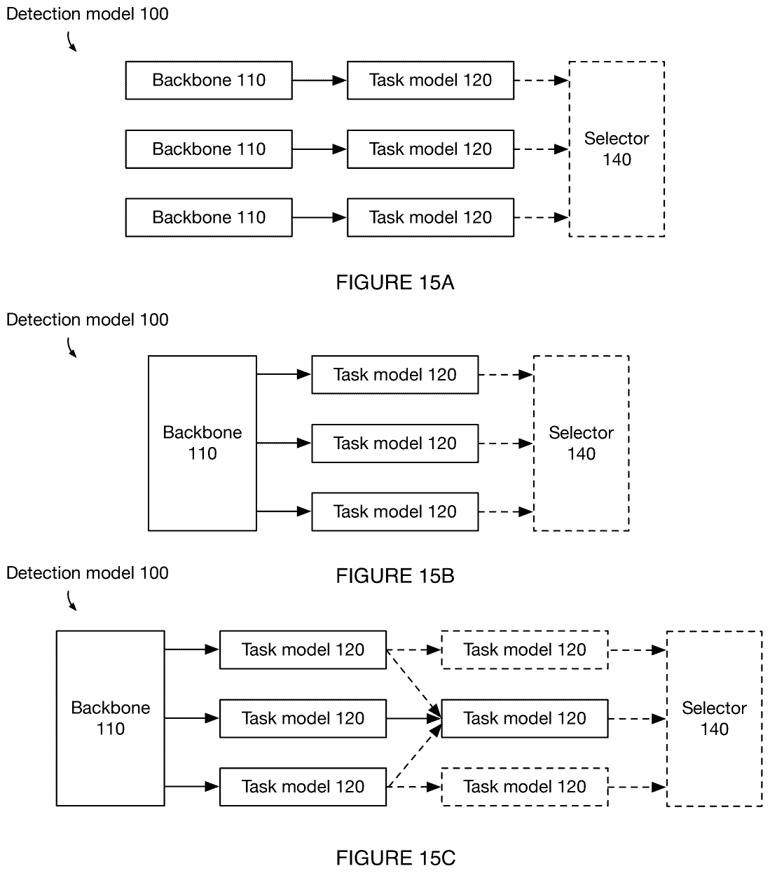

In one variant (e.g., example shown in FIG. 15A), multiple task models can respectively utilize a separate backbone, modeled/arranged in parallel (i.e., each backbone-task model pair acting as a separate, parallel SSD). However, this approach may greatly increase model size and computation complexity and may not allow data backpropagation from each task model during training. Alternatively, in a preferred variant, the task models can share a common backbone, jointly relying on the same set of extracted features (e.g., where only the task models are parallelized), which may improve runtime performance and/or simplify the model complexity (e.g., example shown in FIG. 15B). Additionally, the common backbone may be trained and/or updated based jointly on all task models(s) and/or the class(es) associated therewith (e.g., by backpropagation of errors from all fields, etc.; which may facilitate knowledge sharing and/or machine learning based on all field contexts and/or plant class available in training data). In variants, task models can ingest information output by other task models (e.g., example shown in FIG. 15C). In an example of this variant, a detector head and/or set of detector heads determines a set of detection results and/or components thereof from a set of maps 40 output by other task models 120. As an example, the backbone 110 can include any suitable set[s] of convolutional layers/blocks (e.g., a first set of convolutional blocks which estimate a stem position for each anchor), pooling layers, pre-trained model layers, feature pyramid network(s), residual network layers, and/or any other suitable layer(s)/subnetwork(s).

However, the detection model 100 can include any other suitable backbone(s) for the task models.

In variants, the backbone 110 can be pre-trained and/or (e.g., prior to runtime operation and/or execution of S200 or S230). Additionally or alternatively, the backbone can be trained/updated based on the detection results and/or model outputs, such as by supervised learning (e.g., manually labeled training data), semi-supervised learning, unsupervised learning, and/or any other suitable ML techniques.

### 3.2 Task Models

The detection model 100 can include a plurality of task models 120 which can function to determine information about a field image 20. In a first variant, task models function to generate a map depicting (task) information of a specific type. In a second variant, task models function to detect a plant (e.g., determine the position of an instance of a plant class) and/or classify a specific plant class.

### 3.2.1 Map Prediction Heads

In the first variant, task models 120 can include map prediction heads. In this variant, map prediction heads can determine a map 40 representing information about the field depicted in the field image 20. In this variant, the inputs to the map prediction heads are preferably embedding maps 45 but can additionally or alternatively be field images 20, a vector map, a field plant class prior, a map 40 output from a different task model 120, and/or any other suitable information. In this variant, outputs of the map prediction head can be a map 40, an image, a field plant class, and/or any other suitable information. Map prediction heads preferably consist essentially a set of neural network layers but can additionally or alternatively include other submodels and/or heuristic models (e.g., selectors, etc.) and/or model components with any suitable architecture. In a first variation of this variant, a map prediction head can determine an instance map 41. In a second variation of this variant, a map prediction head can determine a plant class map 42. In a third variation of this variant, a map prediction head can determine a plant component location map 43. In a fourth variation of this variant, a map prediction head can determine an attribute map 44, which can represent any suitable attribute of a field (e.g., plant health parameters, plant burn metrics, plant age, plant growth phase, plant component maturity (e.g., fruit ripeness, etc.), plant mass, and/or any other suitable attributes. Each map prediction head preferably includes a convolutional neural network which is pre-trained/tuned for a respective task (e.g., crop component location, instance identification, etc.), however the plant detector heads can include any other suitable networks and/or ML model(s). As an example, the map prediction heads are preferably SSD (sub-)model heads which are specifically trained for a respective task. The map prediction head is preferably a neural network model head connected to the backbone 110 (i.e., operating on the same set of extracted features as the other task models), but can additionally or alternatively include any other suitable multi-class classification models, and can include one or more: machine learning models, convolutional neural networks, artificial neural networks, ELM, kNN classifiers, Naïve Bayes models, decision trees, Support Vector Machines (SVMs), hierarchical classifiers, and/or any other suitable model(s).

The outputs of the map prediction models are preferably used by plant detector heads to determine detection results; however, detection results can additionally or alternatively be determined as a part of map determination. In such an example, the maps 40 can be refined/filtered, based on the output parameters, to yield a set of detection results, such as by a non-max suppression algorithm, a cost function, rules/heuristics, and/or any other suitable algorithms/techniques (e.g., as part of selector and/or as an element of the plant detector head). For example, maps 40 can be refined based on a heuristic analysis of plant component arrangement (e.g., proximity relative to adjacent plant components and/or the anchors boxes thereof), a min/max detector (e.g., where a map 40 is a heatmap representing an plant attribute at each pixel, plant center likelihood at each pixel, plant component likelihood at each pixel, etc.), a heuristic analysis of pixel values (e.g., determining a region of pixels with a value over a threshold for instance determination, plant component position determination, plant center determination, plant attribute determination, etc.), a classification probability threshold, and/or other refinement criteria.

However, the task models 120 can additionally or alternatively generate maps and/or detection results of any other suitable type.

### 3.2.2 Detector Heads

In a second variant, the task models can include plant detector heads. The plant detector heads are preferably binary classifiers which segment the field image 20, embedding map 45, and/or a map 40 output by another task model into a respective plant class and a background class (e.g., dirt; weeds; volunteer crops; each plant detector head scoring and/or evaluating a hypothesis that the plants within the field/field image 20 match the plant class of the head). More preferably, the plant detector heads are preferably trained to determine a plant component locations (e.g., plant stem location) for each plant (of the target varietal) and based on the visual appearance of the plant (i.e., leaf structure/shape) within a particular field image region (i.e., bounding box ‘anchor’), along classification probability. For instance, some plants may exhibit a high growth density and a high degree of radial symmetry about the stem (e.g., cabbage), while others may have leaves structures with a lower degree of symmetry about the stem (e.g., spinach, tomatoes, etc.). The plant detector heads may leverage such ‘class-specific’ attributes to improve detection/classification accuracy and, more specifically, detection result determination.

Alternatively, the plant detector heads can be multi-class classifiers (of a lower order than the classification model 130) which are specific to a single ‘target’ class of plant. In such variants, the plant detector heads may be trained to discriminate between three classes: a ‘target’ plant class, a ‘non-target’ plant/object class (i.e., volunteer crops, weeds, etc.), and a background class. In a first example, tri-class differentiation can be achieved by compositional, ensemble, and/or cascading methods (e.g., a pair of binary classifiers). In a second example, each plant detector head can include a multi-class classifier configured to differentiate between volunteer crops and the ‘primary’ plant class of the plant detector head.

Each plant detector head preferably includes a convolutional neural network which is pre-trained/tuned for a respective plant class, however the plant detector heads can include any other suitable networks and/or ML model(s). As an example, the plant detector heads are preferably SSD (sub-)model heads which are specifically trained for a respective plant class.

Each plant detector head can output a set of parameters (e.g., as a tensor and/or detection result), which can include: a stem position[s] (e.g., pixel coordinates in field image frame), plant bounding box coordinates (e.g., the anchor), a classification probability/confidence score, an Intersection over Union (IoU) prediction/score, and/or any other suitable parameters (e.g., example shown in FIG. 16). Additionally, each detector and the output parameters can be inherently associated with a respective plant class (i.e., class for which the plant detector head is trained) or an index associated therewith, which can additionally be provided as an output parameter (e.g., for the purpose of post-processing) and/or otherwise associated with the plant detector head outputs, such as to facilitate post-processing and/or NMS.

In a first variation, each plant detector head can determine a set of bounding box coordinates for each detected plant along with a probability/score associated with the classification. Additionally, the plant detector head can generate a plant component location estimate and/or plant component location confidence for the bounding box.

In a second variation, nonexclusive with the first, each detector can evaluate a plurality of candidate bounding boxes (a.k.a., ‘anchor’ boxes) and output, for each anchor: a plant component location estimate, classification probability, an Intersection over Union (IoU) score/prediction, confidences associated with any of the aforementioned parameter values, and/or any other suitable parameter value(s). For example, for N anchors, each plant detector output a tensor comprising the bounding box coordinates (N,4), plant component location estimates (e.g., using a first convolution layer) in field image 20/pixel coordinates (N,2), a binary class score(s) (N, 2), IoU prediction (N, 1), and/or any other suitable parameter value(s). For example, a tensor output may contain 10,000 or more anchors, which may be filtered/refined (e.g., via non-max suppression based on IoU prediction, etc.) to yield a set of detection results. The anchors/field image regions are preferably substantially identical across all model heads (e.g., joint evaluation of same set of anchors; where anchors are predefined and/or provided as an input from a model backbone) but can alternatively be distinct and/or can be otherwise determined.

In a third variation, the plant detector heads can include one or more plant component detectors, which function to detect a specific plant component. The plant component detector can be specific to a plant class or generic (e.g., shared) across plant classes. The detected plant component can be: a stem (e.g., the intersection of the stem with the ground), meristem (e.g., apical meristem, intercalary meristem, etc.), terminal bud, leaf, petiole, axil, flower, and/or other plant component. The plant component detector is preferably a keypoint detector (e.g., trained to detect a keypoint associated with the plant component, determine a keypoint associated with the plant component location, etc.), but can additionally or alternatively be an object detector, segmentation model (e.g., segmentation layers), and/or other model type. The plant component detector preferably ingests features from the backbone 110 (e.g., first set of model layers), but can additionally or alternatively ingest features from another task model or from another set of model layers. The plant component detector can be separate from other task models (e.g., from the first or second plant detector head variants), but can alternatively be part of a plant detector head (e.g., a subset of a plant detector head's layers). The plant component detector can output a keypoint location (e.g., field image coordinate set) associated with the plant component, a confidence score associated with the plant component detection, and/or other outputs.

The plant detector heads can optionally include at least one prediction layer trained to determine an IoU prediction score for the (each) bounding box (e.g., based on the extracted features from the model backbone and/or plant component location estimate). For example, the plant detector heads may generate an IoU prediction for each bounding box (with an additional convolutional layer), which may help the model converge and/or may facilitate global scoring based on both the IoU detection probability (i.e., probability that an anchor box overlaps a crop) and classification probability score (i.e., probability of the embedding encoding a crop). Additionally or alternatively, the IoU prediction may disambiguate between proximal, overlapping, and/or partial detection results. Additionally or alternatively, low probability classifications (i.e., ‘background’ field image regions) may be filtered/suppressed. As an example, where a plant component location estimate for a first anchor box lies within the boundary of a second anchor box, the candidates and bounding boxes may refer to the same object/plant (and are therefore duplicates); all may be suppressed except the anchor with the highest predicted IoU (e.g., local max IoUs may be preserved by NMS). As a second example, where the meristem distance over anchor box intersection ratio (i.e., IoU of the pair of anchor boxes) satisfies a predetermined threshold, the non-max boxes can be suppressed (e.g., lowering the score, etc.).

The plant detector head anchors can be refined/filtered, based on the output parameters, to yield a set of detection results, such as by a non-max suppression algorithm, a cost function, rules/heuristics, and/or any other suitable algorithms/techniques (e.g., as part of selector and/or as an element of the plant detector head). For example, plant detector head outputs can be refined based on a local maximization of IoU predictions, a heuristic analysis of plant component arrangement (e.g., proximity relative to adjacent plant components and/or the anchors boxes thereof), a heuristic analysis of anchor box arrangement (e.g., proximity to an estimated position of an anchor box determined from a prior field image 20, wherein the estimated position is determined based on the position of the anchor box and the camera system delta pose between capturing the prior field image 20 and current field image 20), anchor box intersections (e.g., IoU ratio), a classification probability threshold, and/or other refinement criteria.

### 3.2.3 Outputs

Task model outputs are preferably aggregated and/or refined at a selector layer(s) of the detection model 100 (e.g., receiving the outputs of each head and post-processing to yield detection results) but filtering/refinement can additionally or alternatively be performed within the task model, at another task model, at another element of the model, and/or separately from the model. In an example, a task model 120 includes a spatial embedding model trained to determine a spatial embedding map 46 as well as a post-processor trained to generate an instance map 41 and optionally a set of seed probabilities from the spatial embedding map 46.

Task models are preferably trained/tuned using class-specific data (i.e., disjoint sets of training data may be used to train/update each plant detector head of the plurality), such as using supervised, semi-supervised, and/or unsupervised learning. However, plant detector heads can be otherwise suitably trained/updated with any suitable timing/frequency.

However, task models 120 can be otherwise configured.

### 3.3 Classification Model

The classification model 130 functions to determine a plant class of a field image 20. In variants where task models are plant class-specific, the plant class can be used to select detection results from a respective task model associated with the plant class. Additionally or alternatively, the plant class can be used as a prior for the backbone 110, task models 120, and/or other suitable system components. The classification model 130 can output classification probabilities for the entire field image region of the field image 20 and/or a set of anchor boxes therein. The classification model 130 is preferably a neural network model head connected to the backbone 110 (i.e., operating on the same set of extracted features as the task models), but can additionally or alternatively include any other suitable multi-class classification models, and can include one or more: machine learning models, convolutional neural networks, artificial neural networks, ELM, kNN classifiers, Naïve Bayes models, decision trees, Support Vector Machines (SVMs), hierarchical classifiers, and/or any other suitable model(s). The (multi-class) classification model 130 is preferably unitary/singular and connected in parallel with the plurality of (binary) task models, but can be otherwise configured.

In a first variant, the classification model 130 is preferably a “soft” classifier which outputs a score/probability for each plant class (e.g., of the respective task models and ‘background’ class; for C plant detector heads, the classification model 130 outputs C+1 classification probabilities; an example is shown in FIG. 23) for each anchor box and/or field image region evaluated by (and/or output by) the task models. Additionally or alternatively, the classification model 130 (or the selector 140) may characterize exactly one primary/target plant class for the field image 20 (e.g., which can be used to select a task model and/or outputs therefrom), as being the highest probability plant class for the field image 20 as a whole (e.g., based on an energy maximization, cost function, non-max suppression algorithm, etc.).

In a second variant, the classification model 130 is a “hard” classifier which outputs a single class label or multiple class labels. In this variant, the “hard” classification model 130 output can be binary output, can create a clear decision boundary in a feature space, can contain no probability estimates, and/or can be otherwise characterized.

The classification model 130 is preferably tuned/updated along with at least task model and/or the backbone using a joint set of training data, but can additionally or alternatively be at least partially trained using: a set of training data which is disjoint from the (each) plant detector training dataset(s), synthetic training data, supervised learning (e.g., manually labeled training data), semi-supervised learning, unsupervised learning, and/or can be otherwise suitably trained/updated.

In a first example, the classification model 130 is connected to the backbone in parallel with the task models and can be used to select which task model is relied upon (i.e., which detection outputs remain unsuppressed), using the extracted features from the backbone. In a second example, non-exclusive with the first, the classification model 130 is a task model 120 and/or is essentially the same as a task model 120 (e.g., with the same inputs, outputs, structure, underlying processes, etc.). In a third example, non-exclusive with the previous examples, the classification model 130 is a side process of a task model 120. In a fourth example, non-exclusive with the previous examples, the classification model 130 is a post-processing module which ingests a plant class map 42 and aggregates values (e.g., pixels, etc.) of the plant class map 42 (e.g., by averaging, by finding a modal plant class from the map and/or successive maps, etc.).

Additionally, the classification model 130 can additionally receive a set of prior classifications (e.g., stored at a local memory) as an input. For example, even when performing single shot detections, the prior class determined for the field may inform classification for the current timeframe, even in absence of a common plant instance between frames (i.e., there may be no strict requirement of repeat observation of any plant[s] between frames in order to carry forward information about the plant class of the field). For instance, classifications can be based on a recent time history of plant classifications (e.g., last 3-5 frames, last several seconds, etc.), which may reduce the influence of weeds and/or volunteer crops on classification accuracy.

However, the detection model 100 can include any other suitable plant classification model 130 (s).

### 3.4 Selector

The selector 140 functions to post-process, refine, and/or suppress outputs of the task model(s) to yield a set of detection results. The selector can ingest maps 40, detection results, implied detection results, a field plant class prior, field images 20, and/or other suitable information. Additionally, the selector can output maps 40, detection results, and/or other suitable information. The selector 140 is preferably connected to each task model and receives the output parameters of the plurality of task models 120 and the classification model 130.

In a first variant, the selector 140 combines maps 40 output from task models to determine detection results.

In a first variation of this variant, the selector 140 can determine an instance map 41 to differentiate overlapping plants of different classes. In this variation, the selector can determine plant classes for different instances based on plant class identified for pixels of each instance within a plant class map 42.

In a second variation of this variant, the selector 140 can determine a set of plant component locations (e.g., stem location, etc.) based on the instances. In this variation, the selector can determine a plant component location based on plant component location estimates for pixels of an instance within a stem location estimate map 43.

In a third variation of this variant, the selector 140 can determine a set of plant component locations (e.g., stem locations, etc.) based on plant class regions. In this variation, the selector can determine a plant component location based on plant component location estimates for pixels of a region corresponding to a plant class within a plant class map 42.

In a fourth variation of this variant, the selector 140 can determine metrics about plant populations within a field. In this variation, the selector can label plant instances based on attributes corresponding to the instance represented within an attribute map 44. In an example, plant instances can be labeled with a “burnt” label if they contain pixels corresponding to a “burnt” attribute within the attribute map 44. In a second example, population-level metrics can be collected (e.g., “X % of plants within the field has attribute Y). In a third example, field-level metrics can be collected (e.g., “region Q of the field is growing faster than region R”).

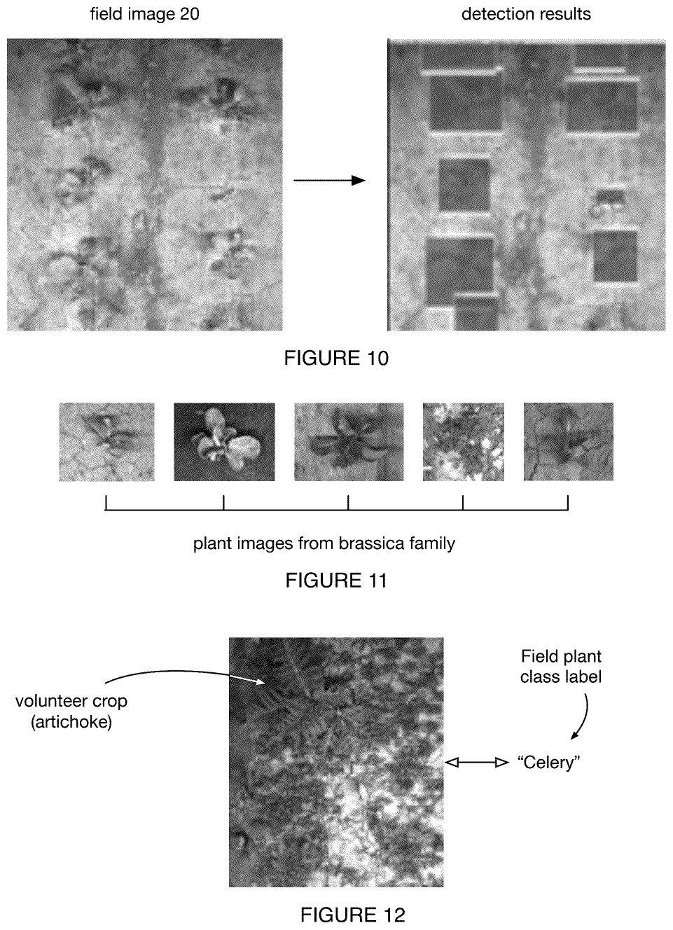

In a second variant, the selector suppresses the outputs of all task models which are not associated with the class of the field, thereby ‘selecting’ the detection result to preserve (and/or the target plant of the field to preserve). As an example, where multiple classes of plants appear in the field image 20, the selected detection result may be preserved in a weeding process, while a remainder of plant matter (i.e., weeds, etc.) may be removed via the weeding process. The selector can refine/suppress outputs with any one or more of: a cost function optimization algorithm (or energy maximization algorithm), non-max suppression (NMS) algorithm, predetermined rules, heuristics, decision trees, probabilistic graphical models, probability distributions, dynamic programs, ML models and/or other models/techniques. The selector preferably returns the (unsuppressed) detection results of the selected plant class (and/or selected task model), while suppressing all non-maxed anchor boxes and outputs from the remaining task models (e.g., an example is shown in FIG. 10).

In a third variant, the selector 140 can refine outputs based on anchor box IoU, plant component locations, and/or a combination thereof. Detection results (e.g., within an individual class and/or globally) can be refined based on the distance between meristems, normalized by bounding box IoU (e.g., IoU value for bounding boxes), where non-maxed, duplicate detections (e.g., normalized meristem distance satisfying a proximity threshold) can be suppressed. Additionally or alternatively, the selector can filter based on classification scores and/or joint classification probability, wherein anchor boxes which do not satisfy a predetermined probability/score threshold may be suppressed. Additionally or alternatively, the selector can filter based on IoU scores, wherein anchor boxes which do not satisfy a predetermined threshold can be suppressed. Additionally or alternatively, the selector can filter based on plant class, where detections for the non-max (non-selected) plant class can be suppressed.

In a fourth variant, the selector can use any one or more of the techniques described in the first, second, and third variants above, in any suitable combination(s) and/or permutation(s).

However, the selector 140 can perform post-processing in any other suitable manner.

In a first example, for N anchors and C task models, a selector can receive C+1 tensors: a respective tensor from each of the C plant detector heads, including: bounding box coordinates (N,4), plant component location estimates (N,2), binary classification probabilities (N,2) or (N,1) for the respective class of the plant detector head, and IoU predictions (N,1) for the anchors; and a multi-class classification tensor (N, C+1) from the classification model 130. The selector returns a selected plant classification and a corresponding set of detections within the selected plant class, each of which can include: a set of scores (e.g., IoU score; multi-class classification score; binary classification score for the plant class; a joint classification probability[ies] for the anchor box; etc.), a plant component location estimate, bounding box coordinates (e.g., the anchor box which maximizes the IoU prediction), and/or any other suitable parameters/results. In a first example, the selector can select a single plant class which maximizes a joint probability of classification and/or maximizes a cost function of classification scores.

In a second example, nonexclusive with the first example, based on the classification model 130 outputs, the selector can determine a score/probability maximizing plant class (and/or the associated task model), refine the outputs for the selected plant class from the associated task model (e.g., suppressing local non-max anchors; filtering anchor boxes with less than a threshold classification probability score and/or IoU score; etc.), and return the refined outputs for the selected plant class, while suppressing all non-maxed outputs (e.g., for all remaining non-max task models and/or non-max anchors). In a specific example, the selector can be a Non-Max Suppression (NMS) post-processor, which determines a set of detection results (for a single class) based on the scores, stem positions, IoU predictions, bounding boxes (e.g., bounding box IoUs), and/or any other suitable parameters.

In a third example, nonexclusive with the first and second examples, the selector may filter/refine outputs based on: temporal data (e.g., recent time history of detections/class), spatial data (e.g., geographic location, such as GPS coordinate position within a predefined field area), HMI inputs (e.g., manual provision[s] of a field index and/or plant class; field class, such as a single plant or multi-plant field; number and/or spacing of crop rows, such as may be derived based on hardware positions, which may be manually set by an operator, etc.), historical data (e.g., historical classifications), spatiotemporal data, relative proximity (e.g., proximity between boxes, such as may be associated with double stems, row spacing, etc.), field parameters (e.g., single plant field, multi-plant field, row spacing, number of rows, etc.; manually, semi-automatically, and/or automatically derived, etc.), and/or any other suitable information/parameters. For example, plant doubles (and/or other multi-plant arrangements) may be detected in post-processing based on a proximity between stems. However, the selector 140 can be configured to post-process outputs based on any other suitable set(s) of parameters/information.

However, the detection model 100 can include any other suitable selector(s) and/or post-processing elements.

### 3.5 Maps

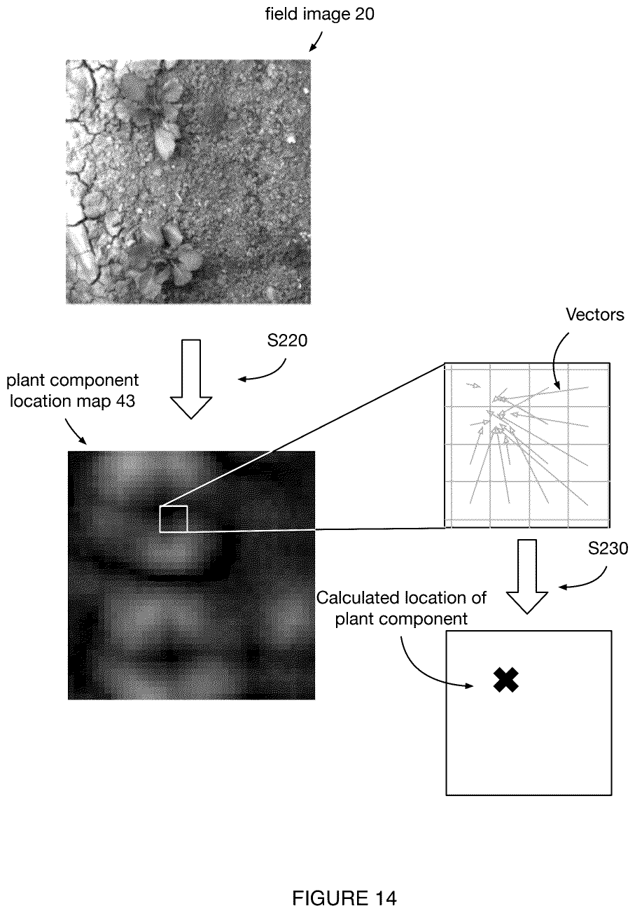

Maps 40 function to represent information about a field and/or plants or rows of plants thereof. Preferably, maps can represent information in pixels corresponding to locations on a field (e.g., as represented by coordinates within the map 40) with any suitable granularity (e.g., pixel height/width, map resolution the same or different from image resolution, etc.). However, maps can additionally or alternatively include a scalar, vector, matrix, and/or can have any other suitable order (e.g., N-order tensor, etc.). Maps 40 can include information structured as tensors, matrices, embeddings, lists, embeddings, graphs, trees, a time series, sets, and/or any other data structure modality. In an example, a map is a 2D array of pixels each containing a vector (e.g., a probability distribution; a positional vector, example shown in FIG. 14; an embedding vector; a scalar value; etc.).

Maps 40 can store information in pixels which can correspond to locations (e.g., in pixel space, real world space, sensor space, etc.) or not correspond to locations. Locations can be 2D, 3D, 3D plus a temporal dimension (e.g., frame timestamp), and/or any other suitable dimension. Locations can be in a world frame, pixel frame, agricultural implement frame, sensor frame, and/or any other suitable frame. Locations can optionally be positions and/or regions within a field image 20, embedding map 45, and/or any other suitable map(s).

Maps can be one-dimensional, two-dimensional, three-dimensional, and/or can have any other suitable dimension. In a first variant, a map 40 is a tensor which is deeper than the field image (e.g., with a depth of K corresponding to K instance, with a depth of C corresponding to C plant classes, etc.). In a second variant, a map 40 is a tensor which has the same depth or is shallower than a field image 20 (e.g., with a depth of 1, 2, or 3, etc.). In variants, pixels of the map can each include a probability distribution, a one-hot encoding, a spatial vector (e.g., in 2D or 3D space), a label, and/or any other suitable information. Labels can include instance labels, plant class labels, plant component location estimates (e.g., vectors in real world space and/or map space), attribute labels (e.g., parasite types, disease types, etc.). In an example, each pixel includes a probability distribution of a location corresponding to each of a set of labels (e.g., plant classes, plant instances, etc.).

Each pixel of the map can be determined based on pixels surrounding the corresponding location in another map (e.g., a field image 20, an embedding map 45, etc.) and/or can be independent of pixels surrounding the corresponding location in another map. In a first example, each pixel value contains an embedding determined exclusively from a corresponding region (e.g., a pixel, a set of pixels) in a field image 20 and/or embedding map 45. In a second example, each pixel value corresponds to a location but is determined from information throughout a field image 20 and/or embedding map 45 (e.g., for embeddings determined by a DNN, etc.). In a first example, each pixel in a map 40 corresponds to a single pixel of field image 20 and/or embedding map 45. In a second example, not necessarily exclusive with the first, each pixel of the field image 20 and/or embedding map 45 corresponds to a pixel of a map 40. However, pixels can otherwise correspond to locations. In a first variant, pixels within the map 40 which correspond to an instance can have different values as other pixels corresponding to the same instance. In a second variant, pixels in the map 40 which correspond to an instance share all or a subset of pixel values.

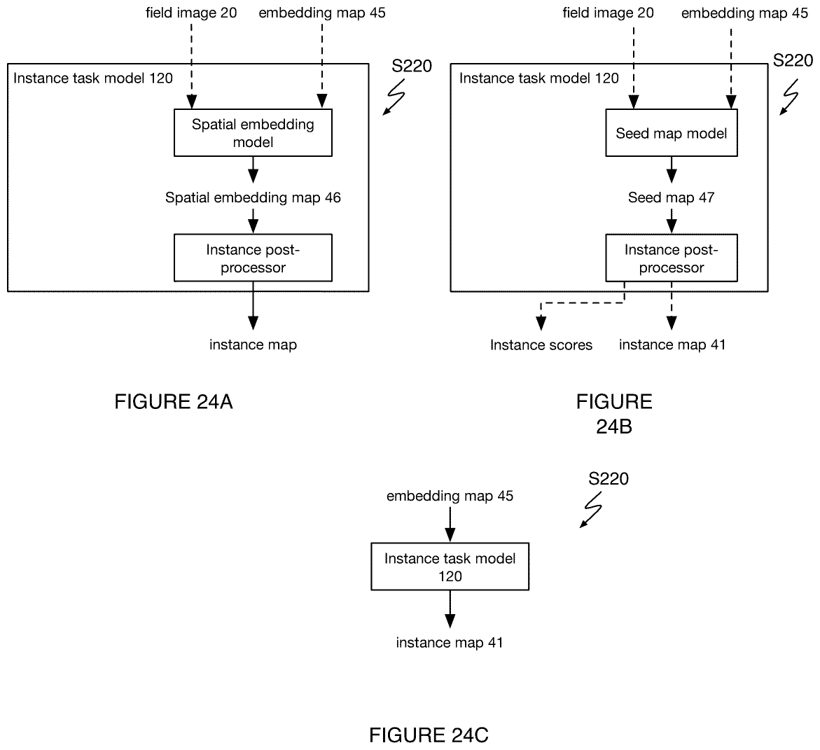

Instance maps 41 function to differentiate plant instances (e.g., plant individuals, even within the same species). Instance maps 41 can be generated directly from the embedding map 45 by an instance task model 120 but can alternatively be generated by post-processing a spatial embedding map 46 generated by the instance task model (e.g., example shown in FIG. 24A). Alternatively, instance maps 41 can be generated from a seed map 47 (e.g., example shown in FIG. 24B). The label of an instance map 41 can represent which of K instances a pixel belongs to (e.g., as a one-hot encoding, as a probability distribution, as a scalar value, etc.) and/or any other suitable information. Each pixel in the instance map 41 can preferably include references to multiple instances for overlapping plants but can alternatively include references to a single instance (e.g., for an instance of highest-confidence, a maximum probability instance according to a probability distribution, etc.). In an example, each pixel contains a probability distribution vector with multiple maxima, where a probability above a threshold value indicates overlapping plants at a corresponding location in the field image 20. In a variant, the instance map 41 can be determined based on the plant component location map 43 (e.g., by determining an instance for each stem, etc.), can be determined independently of the plant component location map 43 (e.g., in parallel), and/or can have any other suitable relationship with the plant component location map 43. However, the instance map 41 can be otherwise configured.

The optional seed map 47 functions to represent seeds for instance determination. The seed map 47 can include instance scores representing the probability of each seed and/or pixel being the center of an instance. However, the seed map 47 can be otherwise configured.

The plant class map 42 functions to differentiate regions of different plant classes from each other. The label of a plant class map 42 can represent which of C plant classes a pixel belongs to (e.g., as a one-hot encoding, as a probability distribution, as a scalar value, etc.) and/or any other suitable information. Pixels of the plant class map 42 can include references to a single plant class and/or multiple plant classes. In a first variant, multiple plant classes can refer to a taxonomical class, a taxonomical order, a taxonomical family, a taxonomical genus, a taxonomical genus, a taxonomical species, a taxonomical varietal, and/or any other suitable type of nested plant class categories. In an example, a probability distribution of the pixel includes high probability at both the species and varietal level (e.g., “cabbage” and “red cabbage”, etc.). In a second variant, multiple plant classes can refer to overlapping plants of different classes. In an example a probability distribution of the pixel includes high probability at both the “crop X” and “weed Y” indices. In this variant, an overlapping plant can be visible in the field image 20, partially visible in the field image 20, and/or not visible in the field image 20.

The plant component location map 43 functions to represent a set of estimates of plant component locations. Plant components are preferably stems (e.g., the 2D or 3D point where a stem meets the ground) but can additionally or alternatively be a harvestable plant component (e.g., a fruit), sexual organs, roots, leaves, flowers, seeds, shoots, buds, inorganic components (e.g., netting, stakes, tags, etc.) and/or other suitable plant components. The plant component location map 43 can be the same map or different map as the instance map 41. In a first variant, each pixel contains an estimate of a location of a nearest plant component and/or a plant component corresponding to the same plant instance as corresponding to the pixel. In a second variant, each pixel contains a distance from a nearest plant component and/or a plant component corresponding to the same plant instance as corresponding to the pixel. In this variant, plant components can be identified in a post-processing step by finding minima and/or maxima of the plant component location map 43. In a third variant, each pixel contains a binary or scalar label representing whether the pixel corresponds to a plant component. In a fourth variant, the plant component location map 43 is a set of plant component coordinates (e.g., where indices of the set do not correspond to known locations, etc.).

The plant component location map 43 preferably includes human-interpretable values (e.g., vectors pointing to the plant component location estimate; example shown in FIG. 14; etc.) but can alternatively include values which are not human-interpretable (e.g., embeddings, etc.). In a specific example, the plant component location map includes a plant stem position estimate at each pixel, wherein each plant stem position estimate can be a vector pointing to a different pixel and/or a location represented by a different pixel, wherein the location is distinct from the location associated with the pixel at which the vector originates. The plant component location map 43 preferably includes at least one plant component location estimate for each pixel but can alternatively include plant component location estimates for a subset of pixels. In a first example, the plant component location map 43 includes plant component location estimates for 1 out of X pixels. In a second example, the plant component location map 43 includes plant component location estimates pixels with high-confidence position estimates only. In a third example, the plant component location map 43 includes nearby position estimates only (e.g., position estimates below a threshold length, etc.). Plant component locations can be a point, a set of points, a 2D region (e.g., a 2D region within a field image 20 and/or embedding map 45), a 3D region (e.g., in real-world space), and/or any other suitable type of location. Plant component locations can be in a global coordinate system, a coordinate system defined by the agricultural implement 400, and/or any other suitable coordinate system.

However, the plant component location map 43 can be otherwise configured.

The attribute map 44 functions to represent attributes of plants and/or attributes of regions of plants and/or a field. Examples of attributes include plant information and/or soil information. Plant information can include plant overall health, plant age (e.g., current growth stage), plant hydration, plant ripeness (e.g., harvest readiness), plant disease type, plant size (e.g., bulk, height, radius around stem, mass, etc.), plant component size (seed size, grain size, leaf area index (LAI), etc.) parasite type, parasite count, infection severity, predicted yield, soil content (e.g., nutrition, etc.), flower density, leaf color (e.g., leaf color index LCI), normalized difference vegetation index (NDVI), canopy cover, plant lodging (e.g., plant bending/breaking). Plant information can correspond to a crop and/or a non-crop plant (e.g., volunteer crops, beneficials, etc.). Soil information can include root structure estimation, soil erosion estimation, soil moisture level, and/or other suitable types of soil information. Additionally or alternatively, the attribute map can include or represent any other suitable attribute(s), derived from the image or otherwise.

The attribute map 44 can represent instances of an attribute, plant instances associated with an attribute, and/or row regions associated with an attribute. In a first variant, the attribute map 44 can represent regions with a particular attribute (e.g., a burnt region, a dead region, an infected region, etc.). In a second variant, the attribute map 44 can represent instances with an overall attribute (e.g., plant age, flower density, disease severity index [DSI], etc.). In this variant, the attribute map 44 can represent attributes within a 2D region (e.g., a blob) corresponding to the instance. In a first variation of this variant, attributes are different for different parts of the region (e.g., estimates for an instance-specific attributes differ between pixels corresponding to the instance, etc.). In a second variation of this variant, attributes are uniform across a region. Alternatively, the attribute map 44 can represent data corresponding to the instance abstractly (e.g., in an instance list, etc.). However, the attribute map 44 can be otherwise configured.

However, maps 40 can be otherwise configured.

However, the system can be otherwise configured.

### 4. Method

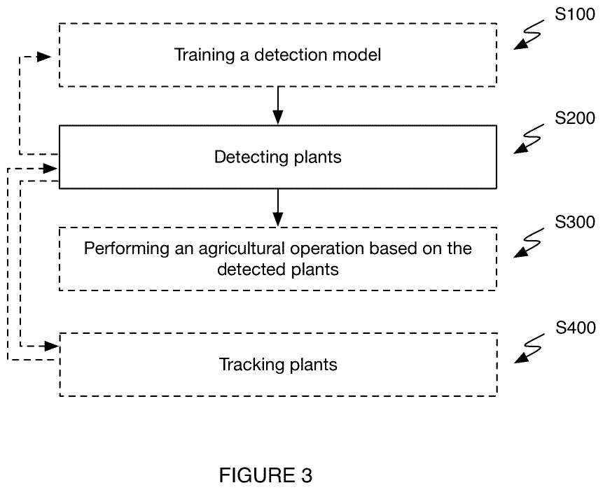

The method, an example of which is shown in FIG. 3, can include: optionally training a detection model S100, detecting plants S200, optionally performing an agricultural operation based on the plant detected by the multi-head detection model S300, and optionally tracking plants S400.

### 4.1 Training

Training a detection model S100 functions to facilitate S200. Additionally or alternatively, S100 can be used to train ‘class’ specific task models and a generalized (non-class-specific) backbone. Additionally or alternatively, S100 can function to update network parameter weights.

In variants, weights for the task model(s) and backbone can be trained by error backpropagation to minimize a gradient loss function. For example, the weights can be updated to minimize the gradient loss as a sum of: task model loss, plant component location loss, bounding box regression loss (e.g., smooth extended IoU loss), IoU prediction loss (e.g., smooth loss between targets and priors for positive classifications), and object classification loss (e.g., normalized by number of positives in the frame).

The backbone 110, task models 120, classification model 130, and/or other components of the detection model 100 backbone can be ‘generically’ trained to all classes and/or field contexts and/or trained on class-specific data. The task models are preferably updated independently/separately (i.e., only trained on labeled field images 20 specific to the corresponding plant class; trained on disjoint training datasets), whereas the backbone and classification model 130 are preferably trained/updated along with each task model (and/or a full training dataset). Target values for training task models can include plant component location, plant class (e.g., of one or multiple plant classes), plant medoid, plant cluster index, plant instance index, a learned center of a plant, plant centroid, and/or any other suitable target value.

The task models can be trained using the same field images 20 as each other (e.g., where each field image 20 is labeled with information relevant to multiple task models) but can alternatively be trained using different field images 20 (e.g., where field images 20 are labeled with information relevant to a subset of task models). In a first example, a plant class task model can train on field images 20 labeled with plant classes. In a second example, a plant component location task model can train on field images 20 labeled with plant component locations. In a third example, an instance task model can train on field images 20 containing counted plant instances. In variants where different field image sets are used to train different task models, the different field image 20 can be used to train the backbone 110 (e.g., wherein the backbone is trained on sets of differently-labeled data) and/or can be distinct from field image sets used to train the backbone 110. However, the model can be otherwise suitably trained/updated using any suitable set(s) of training data.

The detection model 100 and/or components thereof can be trained using hand labeled data (e.g., supervised training) but can additionally or alternatively be trained via supervised learning, semi-supervised learning, unsupervised learning, synthetically generated field images 20, and/or any other suitable training techniques.

In variants, the task models may be trained using field images 20 which do not contain multiple plant classes (e.g., without volunteer crops) but can alternatively be trained with any suitable set(s) of training data.

In variants, the multi-head detection model 100 and/or task models thereof can be updated based on the detection results from S200 (e.g., based on a ground truth comparison, such as against a hand labeled training dataset) with any suitable timing/frequency.

In a variant, an instance task model can be trained to predict a plant component (e.g., a stem), a center of a plant, a medoid of a plant, a learned center of plants, and/or any other suitable instance-specific value.

However, the model(s) can be otherwise suitably trained/updated.

### 4.2 Inference

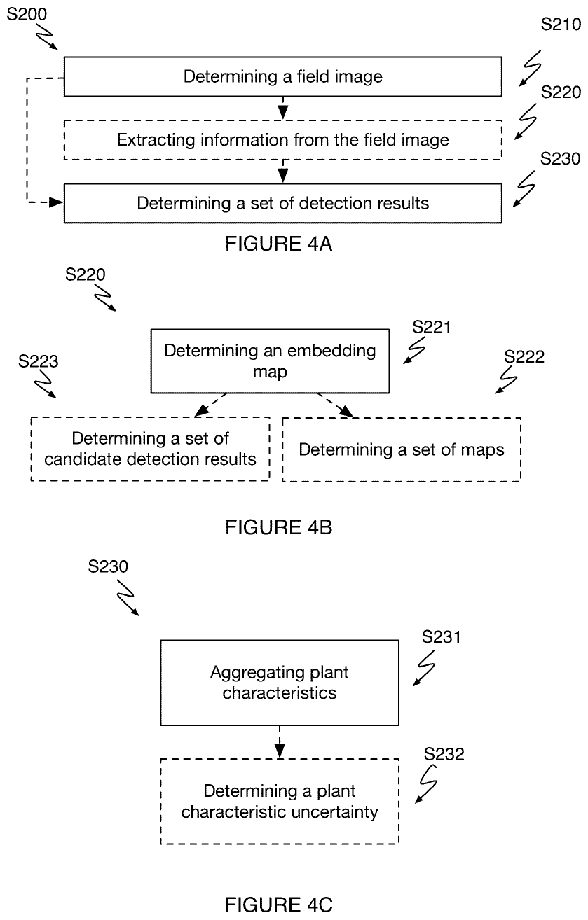

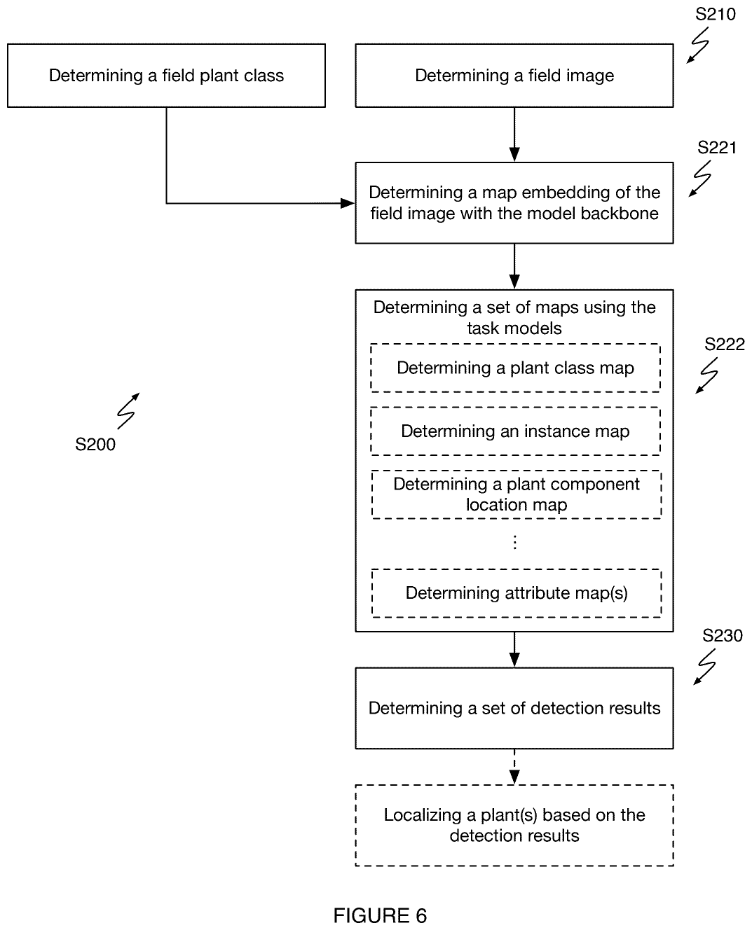

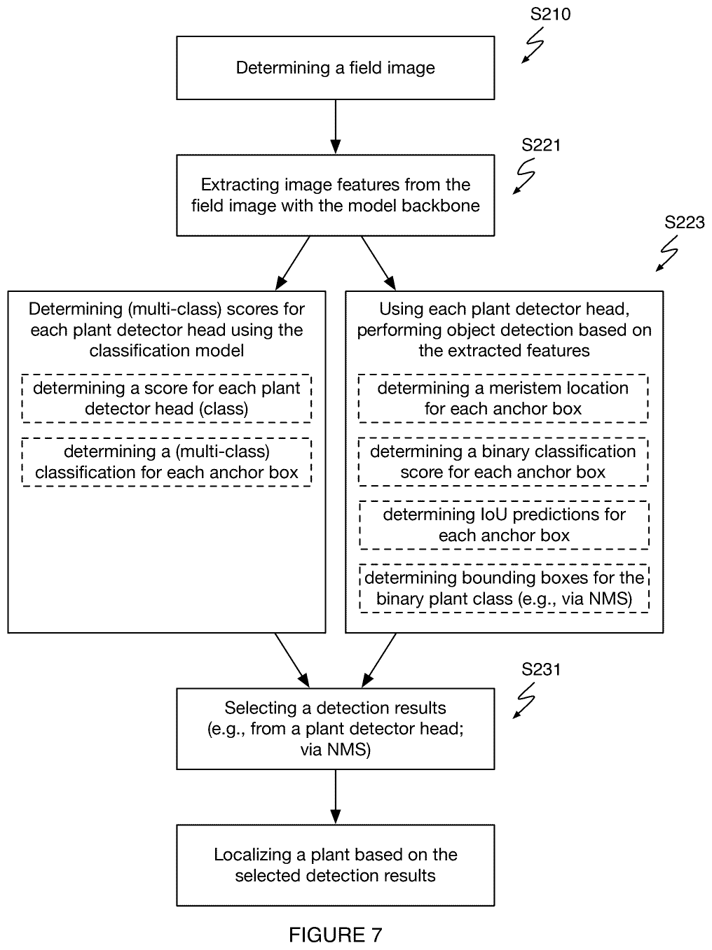

Detecting plants S200, an example of which is shown in FIG. 4A, can include: determining a field image S210; extracting information from the field image S220 (e.g., example shown in FIG. 4B); and/or determining a set of detection results S230 (e.g., example shown in FIG. 4C). S200 functions to facilitate single shot plant detection and localization using the multi-head plant detector 100. Each detection result can include plant positions (e.g., a position of a point where a plant meets the ground), plant bounding boxes, plant stem shapes, plant classification, uncertainties and/or confidences associated with any other aforementioned attributes, and/or any other suitable attribute. The detection results and/or components thereof can be tracked using methods described in S400. Additionally or alternatively S200 can function to facilitate agricultural operations, such as weeding (e.g., in step S300). An example of a variant of S200 is shown in FIG. 6. Another example of a variant of S200 is shown in FIG. 7. The method S200 is preferably executed at the control system 300 (e.g., onboard an agricultural implement 400) using the multi-head detection model 100 and/or the system described above, but can be otherwise implemented. In a variant, implied detection results determined using methods described in S400 can be used alongside detection results determined in S200.

In a first example, S200 can include determining a set of field images 20, determining an embedding map 45 using the backbone 110 of the detection model 100, determining a set of maps 40 (e.g., an instance map 41, a plant class map 42, a plant component location map 43, an attribute map 44, etc.) based on the embedding map 45 using the set of task models 120, and generating detection results by aggregating information in pixels of the set of maps 40 which correspond to plant instances.

In a second example, S200 can include: determining a set of field images 20 over time; determining a set of detection results (e.g., bounding boxes) and a set of preliminary stem positions (e.g., keypoints), with corresponding confidence scores; matching plant instances across the set of field images 20 based on the respective detection results (e.g., based on the bounding box position in world coordinates); determining a stem position based on the preliminary stem positions for each detection result associated with a plant instance (e.g., by triangulating the stem position in world coordinates); determining a stem position uncertainty based on the confidence scores associated with the preliminary stem positions; and determining treatment instructions based on the stem position uncertainty.

Determining a field image S210 functions to generate a field image 20 used for plant detection. S210 is preferably be performed by the camera system 200 but can alternatively be performed by the control system 300 (e.g., wherein the field image 20 is received from a camera system on or off the agricultural implement 400). In an example, the camera system captures field images 20 of the crop row and optionally odometry information (e.g., motion information, etc.) describing agricultural implement 400 motion as the agricultural implement 400 moves over the crop row. S210 is preferably performed concurrently with optionally determining a camera pose S410 but can alternatively be performed at a different time. However, determining a field image S210 can be otherwise performed.

Extracting information from the field image S220 functions to determine features and/or maps 40 corresponding to a field image 20. S220 can include determining an embedding map S221 and optionally determining a set of maps using task models S222. S220, S221, S222, and/or S223 can optionally include using a field plant class prior (e.g., as an input to the backbone 110, task model(s) 120, selector 140, and/or another suitable detection model component). In a first variant, the field plant class prior is set by the agricultural implement 400 operator (e.g., at or near the beginning of an operation session, etc.). In this variant, the field plant class prior can be input and/or selected by the operator via a user interface (e.g., a Human Machine Interface, etc.). Alternatively, the field plant class prior can be determined by a remote entity and transmitted to the control system 300. In a second variant, the field plant class prior can be determined in a prior iteration of the method (e.g., output from the classification model 130). In an example of this variant, when a field plant class prior is not set by the operator, a prediction for field plant class from a prior iteration of the method is used (e.g., from the same or different operation session, etc.). In a third variant, the field plant class prior is determined by other agricultural implements 400 (e.g., received from a control system of a different agricultural implement 400 within a communicatively-connected set of agricultural implements 400). In a fourth variant, different control systems of different agricultural implements aggregate predictions of the present crop row type (e.g., by voting, etc.) based on field images 20 captured independently by a camera system on each agricultural implement 400.

Determining an embedding map S221 functions to determine the embedding map 45. S221 is preferably performed by the backbone 110 but can alternatively be performed by another suitable system component. In a first variant, the backbone ingests the field image 20. In a second variant, the backbone ingests the field image 20 and a field plant class prior (e.g., appended to the field image data, embedding within the field image data, etc.). In an example, the field plant class prior is a one-hot encoding appended to the field image 20. S221 preferably includes determining a single embedding map 45 but can alternatively include determining multiple embedding maps 45 (e.g., each generated using the same or different backbones 110). In a variant, the field plant class prior is appended to and/or encoded with the embedding map 45 output by the backbone 110. However, determining an embedding map 45 S221 can be otherwise performed.

Determining a set of maps using the task models S222 functions to determine maps 40 representing different types of information relating to a field image 20. S222 is preferably performed by the set of task models 120 (e.g., acting as model heads in a panoptic model architecture, where the backbone 110 acts as a panoptic model backbone, etc.) but can alternatively be performed by another suitable system component. S222 is preferably performed at each task head 120 independently with iterations of S222 performed by other task heads, but can alternatively be dependent on S222 performed by other task heads (e.g., performed using the maps 40 output from other iterations of S222 as inputs, etc.). S222 can be performed concurrently with, contemporaneously with, simultaneously with, synchronic with, overlapping with, non-overlapping with, in tandem with, in parallel with, sequentially with, and/or with any other relation to S222 performed by other task heads 120. In an example, an instance map 41 and a plant component map 42 are determined concurrently.

A task model 120 preferably ingests the embedding map 45 (e.g., directly or indirectly) but can additionally or alternatively ingest the field image 20, a field plant class prior, a plant class output from the classification model 130, a map 40 output from a different task model 120, a set of plant instances (e.g., an instance map 41, a list of references to plant instances, etc.), a set of plant components (e.g. a plant component location mop 43, etc.), and/or any other suitable information. In a first example, an instance task model 120 determines an instance map 41 directly based on the embedding map 45. In a second example, plant component location task model determines a plant component location map 43 directly based on the embedding map 45. In a third example, a plant class task model 120 determines a plant class map 42 directly based on the embedding map 45. However, any of the aforementioned maps 40 can be determined indirectly or otherwise determined. The task model 120 preferably outputs a map 40 but can additionally or alternatively output another embedding map 45 (e.g., a spatial embedding map 46), a detection result and/or elements thereof (e.g., plant stem positions, bounding boxes, etc.) and/or any other suitable information.

Each task model 120 preferably generates a map 40 independently of other task models and/or other maps 40 output by other task models, but can alternatively generate one or more maps using the maps output from other task models. In a first example, a plant component location task model determines a plant component location map 43 from the embedding map 45, and an instance task model determines an instance map 41 from the same embedding map 45 independently of the plant component location task model. In a second example, a plant component location task model determines a plant component location map 43 from the embedding map 45, and a plant class task model determines a plant class map 42 from the same embedding map 45 independently of the plant component location task model. However, different task models can otherwise be dependent or independent on each other.

In a first variant, the task model can determine an instance map 41. In a first variation of the first variant (e.g., an example is shown in FIG. 24C), the task model generates an instance map 41 directly from the embedding map 45.

In a second variation, the task model determines an instance map 41 using the embedding map 45 and a known K (e.g., the number of instances depicted in the field image 20).

In a third variation, the task model determines a spatial embedding map 46 from the embedding map 45, which can be post-processed by an instance post-processor to determine the instance map 41. Alternatively, the embedding map 45 can be a spatial embedding map 46, and the task model post-processes the spatial embedding map 46 to determine an instance map 41. The spatial embedding map 46 can include, at each pixel, any or all of: a 2D vector representing an offset of a plant-specific reference point (e.g., a plant component, plant center, plant medoid, a learned center, etc.); a bandwidth σ (e.g., a standard deviation) for each pixel representing precision of the pixel, alternatively interpreted as the radius of the instance, or how close the task model thinks it is able to accurately point to the target; a seed value (e.g., representing the likelihood that the pixel is a center of an instance), and/or any other suitable values. In an example, the spatial embedding map 46 is a tensor with the following dimensions: [Batch size, 4, field image height, field image width]. The spatial embedding map 46 can be translation-invariant, translation-equivariant, and/or can otherwise be affected by translation. The spatial embedding map 46 can be determined based on an embedding map 45, a field plant class prior, a field image 20, and/or any other suitable information.

In a fourth variation of the first variant, the task model 120 determines a seed map 47, which can be optionally post-processed by an instance post-processor to determine the instance map 41. In this variation, the seed map 47 is used to initialize clusters of embeddings which are used to generate seeds. The seed map 47 can include, at each pixel, a probability distribution of the pixel belonging to instances within a set of K instances, a probability of the pixel being the center of an instance, and/or any other suitable information. In this variation, the seed map 47 is preferably not specific to a plant class but can alternatively be specific to a plant class. In an example, seeds are extracted from the seed map 47 by an instance post-processor performing max pooling on the seed map 47 and extracting pixels with seed values above a threshold. K can be determined by counting the number of extracted pixels and optionally eliminating duplicates, but can otherwise be performed.

In a second variant, the task model is a plant class model which functions to generate a plant class map 42.

In a third variant, the task model is a plant component location estimate model which functions to generate a plant component location map 43.

In a fourth variant, the task model is an attribute model which functions to generate an attribute map 44.

In a fifth variant, the plurality of task models 120 can include any one or more of the task models described in the aforementioned variants, in any suitable combination(s) and/or permutations(s).

However, S222 can be otherwise performed.

Determining a set of candidate detection results S223 functions to determine detection results from a field image. S223 is preferably performed by task models 120 in the variant where task models are crop detector heads, but S223 can additionally or alternatively be performed by any other suitable system component. S223 can be performed on the field image 20, the embedding map 45, the output of another task model (e.g., a map 40), and/or any other suitable type of input. S223 preferably outputs detection results (e.g., plant stem positions, bounding boxes, plant boundaries, etc.) but can additionally or alternatively output any other suitable information. In a specific example, S223 is performed on the output of S222. However, S223 can be otherwise performed. However, S223 can be otherwise performed.

However, S220 can be otherwise performed.

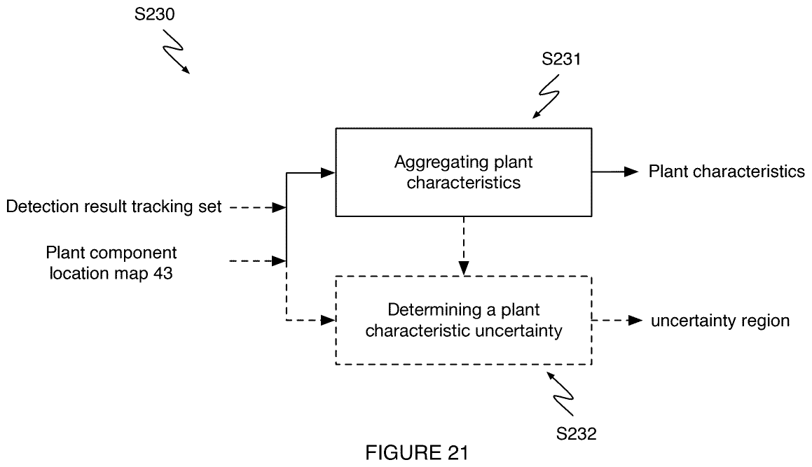

Determining a set of detection results S230 functions to identify and describe plants depicted in a field image 20 to facilitate treatment of the plants (e.g., example shown in FIG. 21). Preferably S230 identifies plant characteristics but can additionally or alternatively identify other suitable objects in the scene. S230 is preferably performed by a selector 140 but can additionally or alternatively be performed by a task model 120, a post-processing stem incorporated within a task model, and/or any other suitable system component. S230 can include aggregating plant characteristics S231 and optionally determining a plant component uncertainty S232.

In variants, post-processing analyses performed as part of S230 can be based on: temporal data (e.g., recent time history of detections/class), spatial data (e.g., geographic location, such as GPS coordinate position within a predefined field area), HMI inputs (e.g., manual provision[s] of a field index and/or plant class; field type, such as a single crop or multi-crop field; number and/or spacing of crop rows, such as may be derived based on hardware positions, which may be manually set by an operator, etc.), historical data (e.g., historical classifications), spatiotemporal data, relative proximity (e.g., proximity between boxes, such as may be associated with double stems, row spacing, etc.), field parameters (e.g., single crop field, multi-crop field, row spacing, number of rows, etc.; manually, semi-automatically, and/or automatically derived, etc.), and/or any other suitable information/parameters. For example, plant doubles (and/or other multi-plant arrangements) may be detected in post-processing based on a proximity between stems. Additionally, variants may facilitate automatic (and/or semi-automatic, such as based on an HMI validation) switching of applicable model heads based on geo-location and/or prior knowledge of a field region.

Aggregating plant characteristics S231 functions to generate information (e.g., plant attributes, plant component locations, etc.) from a set of maps 40, an embedding map 45, a field image 20, a detection result tracking set, a set of candidate detection results output from a set of task models 120, a field plant class prior, and/or any other suitable information.

In examples, plant characteristics can include plant component locations, bounding box positions, plant size, plant center, plant attributes (e.g., “burnt”, “dead”, “young”, “ready for harvest”, “dry”, etc.), plant class, plant instance label, and/or any other suitable plant characteristics. Plant component locations can include a point where a plant stem meets the ground, harvestable plant component (e.g., fruit, stalk, leaf, etc.) location, leaf locations, root locations, and/or any other suitable plant component location. The plant component location can be a point in world space, can be a point in pixel space, can be a 2D or 3D shape, and/or can take any other suitable form. The plant component location can be defined relative to a point on the system (e.g., a point on an agricultural treatment implement) or a point off the system. The plant component location can be determined based on detected plant component locations (e.g., detected plant component keypoints), detection result bounding boxes, from auxiliary data (e.g., detecting the plant component's geometry in 3D data), and/or other plant component data.

Plant characteristics can be aggregated from information from different parts of a field image 20 and/or different field images 20. In a first variant, plant characteristics are aggregated from different detection results (e.g., from the same field image 20, from different successively-captured field images 20, from a detection result tracking set, etc.).

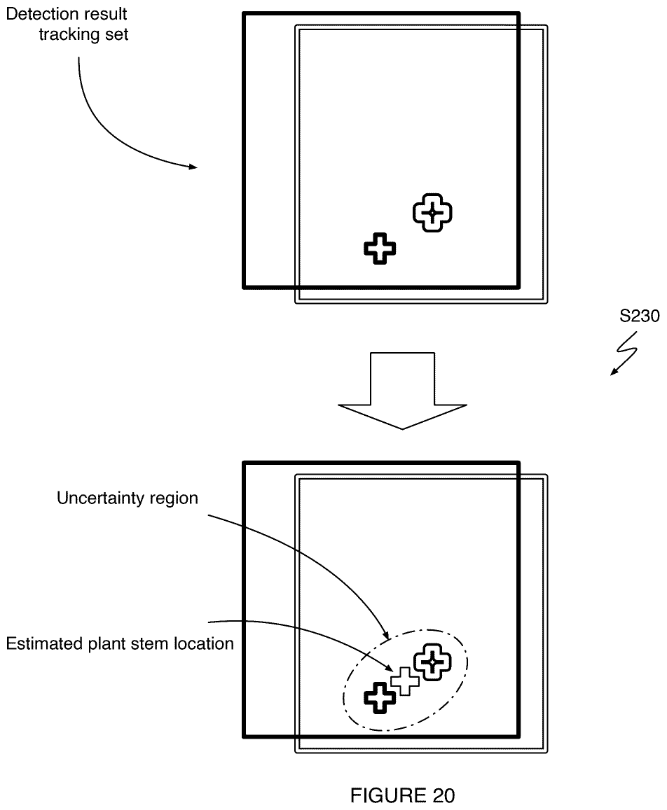

In a first variation of the first variant, the plant characteristics (e.g., plant component location) can be calculated by aggregating (e.g., averaging, voting, etc.) plant characteristics from different detection results within a detection result tracking set determined for the plant (e.g., example shown in FIG. 20). In a second variation of the first variant, plant characteristics can be calculated by combining weighted plant characteristics from different detection results within a detection result tracking set, wherein plant characteristic weights are based on a detection result confidence score, temporal distance between a current field image 20 and a field image 20 corresponding to a detection result, a plant characteristic confidence score (e.g., generated at a task model 120 alongside the plant characteristic), a bounding box confidence score, and/or any other suitable factor. In a third variation of the first variant, plant characteristics are a plant component location which minimizes the average distance to each of a ray between the camera system and an estimated plant component location (e.g., the ray representing a pixel location deprojected into 3D space and interpolated based on camera position) for each detection result. In a fourth variation of the first variant, a set of candidate plant characteristics are generated based on combining a set of triangulations of 3D meristem locations from detection results. In a fifth variation of the first variant, plant characteristics can be aggregated from overlapping or proximal detection results generated from a field image 20. However, the plant characteristics can otherwise be determined. However, the first variant can be otherwise characterized.

In a second variant, plant characteristics are aggregated from pixels representing basis regions (e.g., plant instances, plant class regions, non-ground regions, a plant shape surrounding a plant component location, for example, a basis region defined by a plant center and a radius, etc.) within a set of maps 40. Basis regions can be represented as a binary map extracted from a plant class map 42, instance map 41 (e.g., via thresholding, etc.), a binary map generated by making a shape from a plant component location, and/or any other suitable map 40, and/or any other suitable map. In a first example, for each plant instance, S231 includes aggregating plant characteristics (e.g., plant component location estimates, etc.) from pixels corresponding to the respective plant instance. In a second example, S231 include aggregating plant characteristics for a region corresponding to a plant class (e.g., a countable or uncountable bush of one or multiple plant instances, etc.). In a third example, S231 include aggregating plant characteristics for a region corresponding to a “plant” label (e.g., in a binary map distinguishing plant from ground, etc.).

Aggregation can include using classical programmatic algorithms, machine learning-based methods, statistical methods, heuristics, rule-based methods (e.g., voting, etc.), and/or any other suitable type of aggregation. In a first example, pixels corresponding to a basis region (e.g., a plant instance, etc.) vote for a plant characteristic (e.g., a plant component location, etc.). In a second example, pixels corresponding to a basis region have their values averaged, clustered, modalized, medianized, and/or otherwise combined. Values for aggregation can be weighted by distance from an instance center, weighted by a length vector (e.g., pixels indicating a distant plant component location estimate may be less likely or more likely to be reliable than pixels indicating a close plant component, etc.), weighted by a confidence value, not weighted, and/or otherwise weighted. Aggregation can include aggregating pixel values to a single output value and/or multiple output values (e.g., multiple plant component location estimates for an uncountable set of instances, etc.).

However, S231 can be otherwise performed.

Optionally determining a plant characteristic uncertainty S232 functions to determine an uncertainty value and/or uncertainty region corresponding to a plant characteristic. An uncertainty region can be a 2D or 3D shape (e.g., an ellipse, ellipsoid, rectangle, a cuboid, etc.) at a fixed position relative to the plant stem; a function of an x, y, and/or z position in world space or pixel space (e.g., a 2D or 3D uncertainty map); a boundary surrounding a 2D or 3D region with a certainty above a threshold defined by the aforementioned function, and/or any other suitable type of uncertainty region. The uncertainty region can correspond to plant characteristic uncertainty, plant component location uncertainty, detection result uncertainty (e.g., classification confidence, bounding box position and/or size uncertainty, etc.), and/or any other suitable uncertainty related to the plant. The uncertainty can be generated based on uncertainties calculated alongside plant characteristics (e.g., uncertainty associated with map values, uncertainty associated with detection results and/or components thereof output by task models, and/or any other suitable type of uncertainty), uncertainties generated based on a variance (e.g., and/or mean, skewness, kurtosis, and/or any other suitable type of central moment) of a set of estimates of plant characteristics (e.g., from a detection result tracking set, from different values of a map 40, etc.). The uncertainty region can be generated by: averaging the distance from a plant component location determined in S231 and each candidate plant component location estimate (e.g., from the plant component location map 43 42, from plant component locations in detection results, etc.), determining a covariance matrix from all of the closest 3D points to the determined plant stem position (e.g., to determine an ellipsoid-shaped uncertainty region), generating a convex hull, generating a minimum-volume bounding box, using a heuristic region associated with the plant stem confidence score, and/or using any other suitable method. In an example, the uncertainty region can additionally be based on a risk tolerance (e.g., an uncertainty threshold) applied to a 2D or 3D uncertainty map. The uncertainty region can incorporate or not incorporate confidence information from each detection result within a detection result tracking set when considering information from a respective detection result (e.g., plant component locations associated with different detection results are weighted differently when determining a plant stem uncertainty). The uncertainty region can be calculated in world coordinates, unrectified pixel coordinates for a current field image 20, rectified pixel coordinates for a current field image 20 and/or any other suitable coordinate system. In an example, an uncertainty region size can be inversely proportional to the uncertainty of a plant component location (e.g., plant stem position).

However, S232 can be otherwise performed.

In a variant, S230 can additionally include evaluating whether a detection result tracking set corresponds to an actual plant. In a variant, a median confidence of the detection results within a detection result tracking set can be determined, and detection result tracking sets with a confidence of zero (e.g., the corresponding plant was observed in less than half of the field images 20 in which they should have appeared given the camera position, etc.) are considered to be anomalous (e.g., false positive) detections and are ignored. Alternatively, a different heuristic can be used to infer plant existence (e.g., plants appearing in fewer than a predetermined percentage or number of field images 20 can be ignored). However, whether a detection result tracking set corresponds to an actual plant can be otherwise determined.

However, S230 can be otherwise performed

However, S200 can be otherwise be performed.

### 4.3 Control

The method can optionally include performing an agricultural operation based on the detected plants S300. The agricultural operation can include weeding, spraying, marking, applying a treatment (e.g., medicine, fertilizer), harvesting, and/or any other suitable agricultural operation. Control instructions for S300 are preferably performed at an implement control module 310 corresponding to an agricultural implement 400 but can additionally or alternatively be performed by control system 300 and/or any other suitable system component or subcomponent thereof. In variants, S300 can additionally or alternatively include any of the agricultural implement controls performed by the “system 100” and/or “controller 240” (e.g., acting as the control system 300 and/or implement control module 310) described in U.S. application Ser. No. 18/435,924 filed Feb. 7, 2024, incorporated herein in its entirety by this reference. In variants, S300 can additionally or alternatively include any of the agricultural implement controls performed by the “system 100” and/or “computing system” (e.g., acting as the control system 300 and/or implement control module 310) described in U.S. application Ser. No. 18/435,730 filed Feb. 7, 2024, incorporated herein in its entirety by this reference.

The agricultural implement 400 which performs the agricultural operation (e.g., according to the control instructions) can include: a blade set, laser, sprayer (e.g., of a pressurized fluid), heating mechanism (e.g., a heat gun), fertilizer applicator, and/or any other suitable agricultural implement 400. In a specific example, the agricultural implement 400 is a pair of actuatable blades which trace a path around a plant of interest in order to weed non-plants of interest. The agricultural implement 400 can be controlled by the control system 300, an implement control module 310, and/or any other suitable system component. The implement control module 310 can be integrated with the agricultural implement (e.g., specific to the agricultural implement 400) but can alternatively be separate from the agricultural implement (e.g., communicatively connected with an effector of the agricultural implement 400).

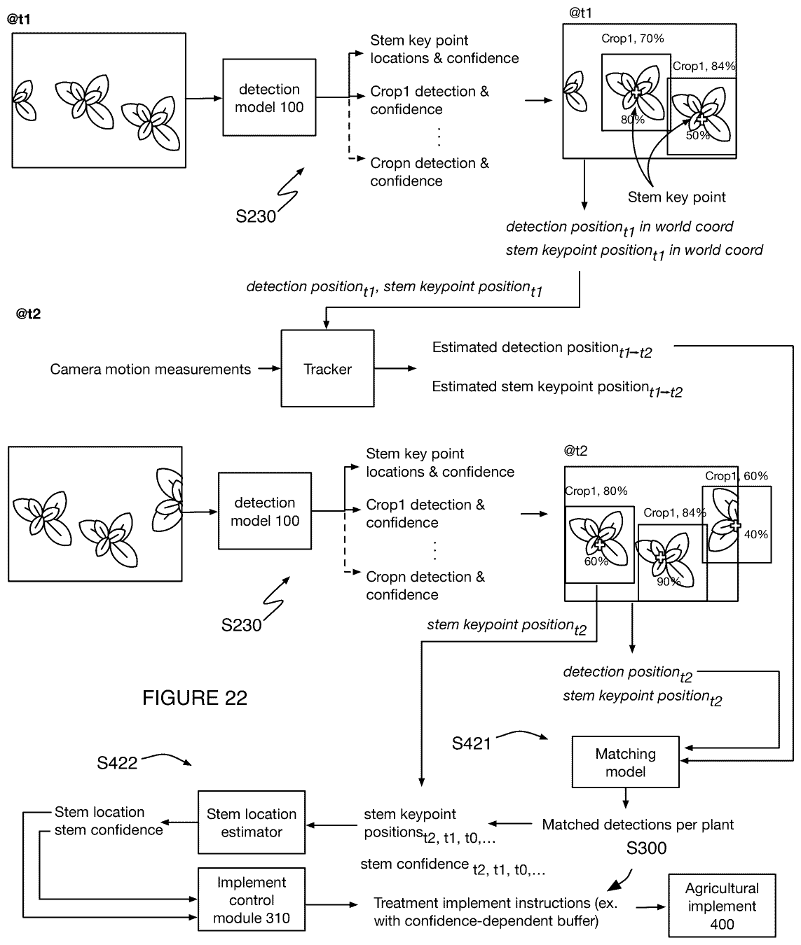

The agricultural operation can be performed using information determined about the plants in S200 (e.g., the plant stem position and/or uncertainty, detection result tracking set, detection results, and/or any other suitable information). Performing the agricultural operation based on the information can include actuating an agricultural implement 400 (e.g., a blade) around a plant stem position and/or uncertainty region; actuating an agricultural implement 400 to specifically treat a crop row at and/or proximal to a plant stem position and/or uncertainty; keeping an agricultural implement 400 fixed but otherwise controlling the agricultural implement 400 (e.g., spraying, taking photos, etc.) based on the information; and/or otherwise performing an agricultural operation. The boundaries along which the agricultural implement actuates can be boundaries of an uncertainty region, boundaries of another suitable region type (e.g., a region representing a plant class type, a region representing a plant instance), boundaries of a plant component and/or uncertainty region thereof (e.g., an ellipse defined relative to a center point, etc.), and/or any other suitable type of boundaries. In an example, the agricultural implement is controlled based on a moment of a set of estimates of a plant component location (e.g., a plant stem location estimated at each of a set of pixels in a plant component location map, etc.). In a set of examples, a set of boundaries are generated based on the uncertainty regions determined in S232, wherein the boundaries represent an adjustable uncertainty threshold (e.g., wherein a user can adjust the uncertainty threshold and/or an uncertainty threshold can be automatically determined). In a first example of the set, the agricultural implement 400 is actuated to avoid crossing the boundaries (e.g., to protect each plant within a margin of error given an assumption of imperfect plant stem position estimation). In a second example of the set, the agricultural implement 400 path is actuated to avoid coming within a threshold distance of the uncertainty region and/or boundary determined based on the uncertainty region (e.g., example shown in FIG. 22). A boundary based on the uncertainty region can be a boundary defined by a threshold distance from an uncertainty region (e.g., defining a treatment buffer zone), a boundary formed by tracing an equal-uncertainty path through a gradient uncertainty map (e.g., where the uncertainty region is a function representing uncertainty at different x, y, and/or z coordinates), and/or any other suitable boundary. In a specific example, the boundary is an ellipsoid uncertainty region, where the size of the ellipsoid has an inverse relationship with uncertainty. However, the boundary can be otherwise determined.

During operation, the agricultural implement can actuate based on between different modes of performing S300. In a first example, when the agricultural implement traverses countable plant instances (e.g., where plants are discrete and sufficiently far apart, the agricultural implement can base actuation on instance-specific regions (e.g., plant boundaries, plant component positions, etc.). In a second example, when the agricultural implement traverses non-countable plant instances (e.g., where plants are overlapping, touching, and/or otherwise difficult to differentiate from each other), the agricultural implement can actuate based on plant class- and/or row-specific regions (e.g., boundaries of a region of a field image 20 and/or embedding map 45 corresponding to a particular plant class). In further examples, the agricultural implement can switch between the aforementioned different modes while traveling over a field (e.g., where the agricultural implement traverses both countable and non-countable plants in an operation period). In a specific example, the agricultural implement can determine an operation mode (e.g., countable plant operation mode or non-countable plant operation mode, etc.) at each iteration of the method (e.g., for each of a subset of field images 20, etc.). In an example of a countable plant operation mode, the agricultural implement performs weed cultivation in between individual plants on a row without cultivating a predetermined plant type (e.g., a crop). In an example of a non-countable plant operation mode, the agricultural implement performs weed cultivation between rows (e.g., on the boundaries of a plant class region). However, countable plant operation modes and/or non-countable plant operation modes can be otherwise defined.

However, the agricultural operation can be otherwise performed.

### 4.4 Tracking

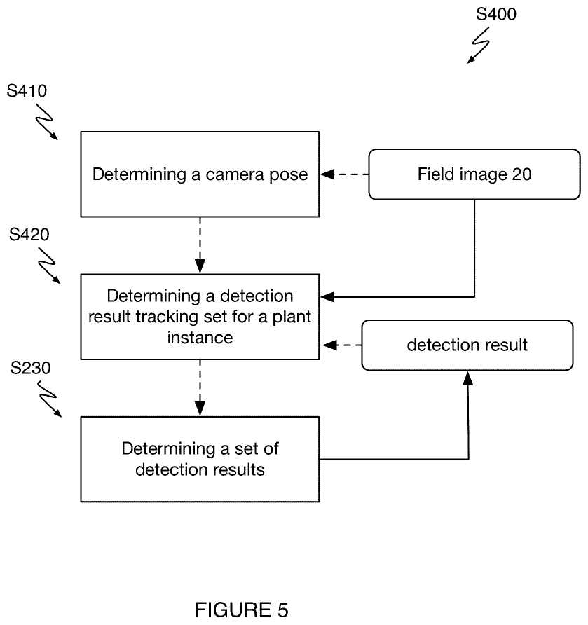

The method can optionally include tracking detection results S400 (e.g., example shown in FIG. 5), which functions to track plants through successive field images 20 captured by the camera system 200 during operation. Tracking detection results can enable (e.g., plant characteristics) determined for a plant in a first field image 20 to apply to and/or inform the determination of plant characteristics for the same plant in future field images 20 and/or cached prior field images 20. S400 and/or elements thereof are preferably performed at the control system but can additionally or alternatively be performed by other suitable system components. S400 is preferably performed iteratively for each field image 20 in real-time or substantially in real-time; however, S400 and/or elements thereof can be performed at other suitable times. S400 can include determining a camera pose S410 and/or determining a detection result tracking set S420. Detection results and/or components thereof are preferably tracked in world coordinates (e.g., converted from pixel coordinates to world coordinates based on the camera calibration and camera pose), but can additionally or alternatively be tracked in pixel space or another space.

Determining a camera pose S410 functions to determine the camera pose at the sampling time. All or portions of the camera pose can be determined using: dead reckoning, odometry (e.g., VO, VIO, etc.), a direct measurement (e.g., using a feeler wheel, depth measurement, GPS measurement, altimeter, etc.), and/or otherwise determined. In an example, the camera (x,y) position can be determined using VO (e.g., using visual features tracked in the field images 20), VIO, dead reckoning (e.g., from system accelerometer measurements, encoder measurements, etc.), and/or otherwise determined based on a prior camera position and a determined position change over time. The camera z position can be determined from a feeler wheel measurement, stereo measurement, or other depth measurement. The camera pose can be associated with a camera pose confidence and/or uncertainty. The camera pose can be determined based on field images 20, maps 40, other measurements, and/or other suitable information. S410 is preferably performed at the control system 300 but can additionally or alternatively be performed by the camera system 200 and/or any other suitable system component. However, S410 can be otherwise performed.

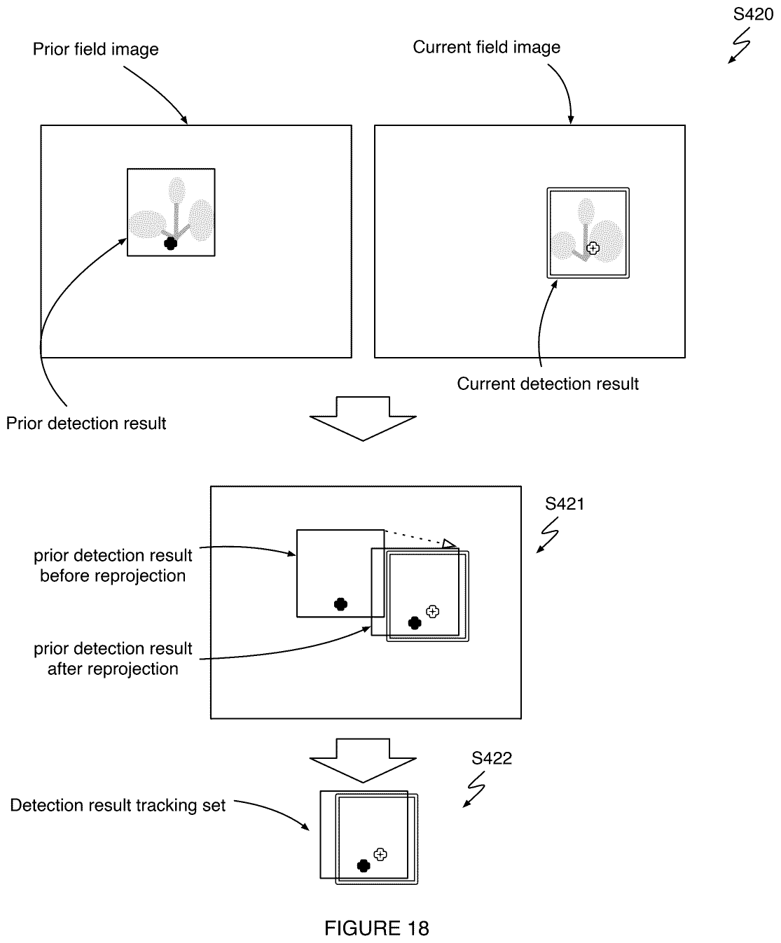

Determining a detection result tracking set S420 can function to track the position of a plant through multiple field images 20 (e.g., example shown in FIG. 18). A detection result tracking set can be a set of detection results which represent the same tracked object (e.g., a plant instance, a plant class region, a same region of a field, a same plant component, and/or any other suitable object and/or feature thereof represented in field images 20). The detection result tracking set is preferably made of detection results determined from different field images 20 but can alternatively include detection results determined from the same field image 20. A detection result tracking set can include detection results for a tracked object in each consecutive field image 20 in a time series but can alternatively include detection results from non-consecutively captured field images 20. A detection result tracking set can include detection results of only one plant class but can alternatively include detection results for multiple different plant classes. In variants, detection results within a detection result tracking set can include or not include information about the camera position at the time of capturing the field image 20 associated with the detection result. A detection result tracking set can include an overall confidence determined based on the confidences associated with the detection results within the detection result tracking set.

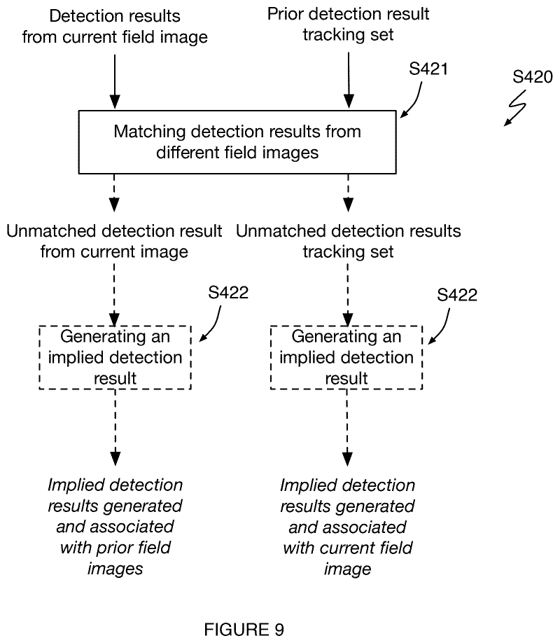

S420 is preferably performed iteratively for each object and/or tracked object in a field image 20 but can alternatively be performed any other number of times. S420 is preferably performed after determining a camera pose S410 and/or generating a set of detection results S230, but S420 can be performed at any other suitable time. Inputs to S420 can include a current field image 20, a set of prior field images 20, a set of changes in pose of the camera system (e.g., odometric information, etc.), and/or any other suitable information. The set of prior field images 20 can be captured by the same camera system or different camera system as captured the current field image 20. In variants, the set of changes in pose of the camera can each correspond to a prior field image 20 within the set of prior field images 20 and the current field image 20 or a different field image 20 within the set of prior field images 20. The current field image 20 is preferably overlapping with field images 20 within the set of prior field images 20 but can alternatively not be overlapping. The detection result tracking set is preferably in world coordinates (e.g., 3D coordinates), but can additionally or alternatively be in pixel space. A detection result tracking set can be determined by matching detection results from different field images S241 and/or generating an implied detection result S242 (e.g., example shown in FIG. 9).

Matching detection results from different field images S241 can function to determine which detection results belong in the detection result tracking set (e.g., example, shown in FIG. 18). Detection results can be matched when a detection result determined from the current field image 20 has a similar location to a detection result determined from a prior field image 20 and/or using any other suitable heuristic or non-heuristic method (e.g., using a trained model). The detection results are preferably matched in 3D space (e.g., wherein the detections are converted from field image 20 or pixel space to a 3D reference frame using the camera calibration and measured or estimated camera pose), but can alternatively be matched in pixel space and/or in any other suitable space. In a first variant, the location of each detection result is directly compared. In a second variant, the location of the prior detection result is adjusted based on a change in pose of the camera system between capturing the prior field image 20 and capturing the current field image 20, and the resulting adjusted prior detection result is compared to a detection result determined from the current field image 20. In a third variant, the location of the current detection result is adjusted based on the change in pose of the camera system and the resulting adjusted current detection result is compared to a detection result determined from a prior field image 20. However, detection results can be otherwise compared. Comparison of locations of detection results can include determining a pixel distance between detection results, determining an overlap amount of detection results (e.g., whether the detection results overlap by a threshold percentage), comparing features determined from detection results (e.g., comparing encodings each determined from a detection result), and/or any other suitable method or set of methods. Comparing detection results can include comparing bounding boxes (e.g., anchor boxes) or features of bounding boxes (e.g., center points, etc.), estimated plant component location, and/or any other suitable attribute of detection results. Preferably, matching can only occur between detection results of the same plant class; however, matching can otherwise be performed. In a first specific example, matching detection results can include determining whether the bounding boxes associated with a detection result from the current field image 20 and a bounding box associated with a detection result from a prior field image 20 are overlapping and generating a match when the bounding boxes overlap above a threshold (e.g., using Intersection over Union, etc.). In a second specific example, matching detection results can include determining whether points (e.g., a plant component location, a bounding box center) associated with a detection result from the current field image 20 and a detection result from a prior field image 20 are within a threshold distance (e.g., pixel distance or world distance). A confidence score can be associated with each matching pair and/or detection score tracking set based on the confidence of classifications of detection results, a matching degree (e.g., IoU score; pixel distance, etc.), and/or any other suitable factor. However, S421 can be otherwise performed.

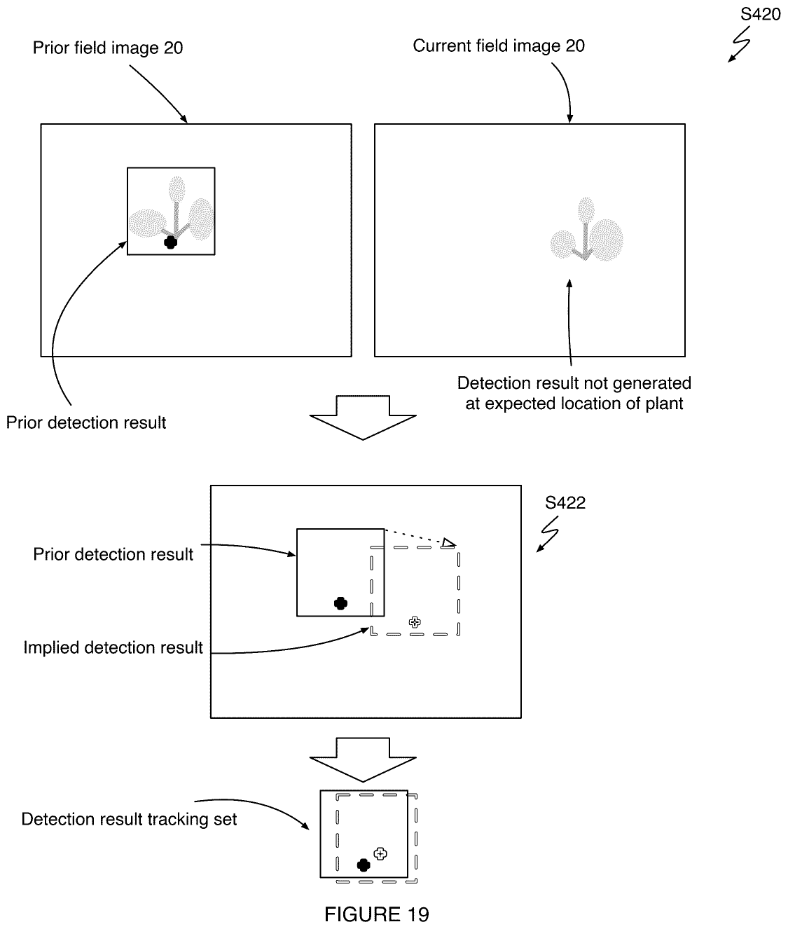

Generating an implied detection result S422 can function to generate stand-in detection results to add to a detection result tracking set (e.g., example shown in FIG. 19). In the circumstances where S200 does not detect all plants expected to appear in the respective field image 20 based on detection results determined from another field image 20 (e.g., wherein the other field image 20 is a prior-captured, concurrently-captured, or subsequently-captured field image 20), mistakenly inferring non-existence of a plant could result in killing or not treating a target plant. Thus, the system can infer the location in a current field image 20 where a detection result could exist based on a different detection result from a different field image 20 and a delta pose between the camera capturing the current field image 20 and the camera capturing the different field image 20. The location can be inferred based on a reprojection of the detection result into the current field image 20 (e.g., example shown in FIG. 18), but the location can alternatively be inferred by any other suitable method. The system can then assign the inferred location to a stand-in detection result. The system can assign a zero confidence score, low confidence score, or confidence score of another magnitude to the inferred detection result. Generating an implied detection result S242 can be performed responsive to an unmatched detection result being present in a current field image 20 after S241, an unmatched detection result being present in a prior field image 20 after S241, and/or responsive to any other suitable condition. Generating an implied detection result is preferably performed after rectifying the prior field image 20 to the current field image 20 (e.g., using the camera system delta pose) but can alternatively be performed without rectification. Generating an implied detection result can include adding attributes to an existing detection result. For example, when a detection result in a current field image 20 includes a bounding box but no plant component location, a plant component location can be inferred and associated with the detection result in the current field image 20 based on the camera delta pose between the two field images 20.

However, S422 can be otherwise performed.

However, S420 can be otherwise performed.

However, S400 can be otherwise performed.

However, the method can be otherwise performed.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Variants of the system and/or method can be used to facilitate detection and/or agriculture operations for single plants, multi-plants (e.g., plant doubles, where agriculture operations may be based on stem proximity), ground cover plants, weeds, and/or agriculture operations in any other suitable scenarios.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUS, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim

1. A method for crop treatment, comprising:
capturing an image of a crop row using a set of sensors onboard an agricultural implement;
at a processing system comprising a multi-head model:
with a model backbone of the multi-head model, determining an embedding map for the image;
with a first model head of the multi-head model, determining a crop species map using the embedding map, wherein the crop species map comprises a first 2D array of elements each representing a location and a set of crop species; and
using a second model head of the multi-head model, determining a plant stem position map using the embedding map, wherein the plant stem position map comprises a second 2D array of elements each representing a location and an estimate of a relative plant stem position; and
based on both the crop species map and the plant stem position map, controlling the agricultural implement along the crop row.

2. The method of claim 1, further comprising determining a plant stem position by aggregating a subset of estimates of relative stem plant positions from the plant stem position map.

3. The method of claim 2, wherein aggregation comprises voting.

4. The method of claim 2, wherein the agricultural implement is controlled based on a moment of the subset of estimates.

5. The method of claim 2, wherein the subset of estimates each correspond to a single plant instance.

6. The method of claim 1, further comprising, at the processing system, with a third model, determining a plant instance map, wherein the plant instance map comprises a third 2D array of elements each representing a location and a set of plant instances.

7. The method of claim 6, wherein the plant stem position map is determined independently of the plant instance map.

8. The method of claim 7, wherein the plant stem position map is determined independently of the crop species map.

9. The method of claim 6, wherein each of a subset of elements of the third 2D array in the plant instance map corresponds to multiple plant instances.

10. The method of claim 1, wherein the crop species map is determined based on a field crop type corresponding to a crop type of a current operation period.

11. The method of claim 1, wherein the embedding map comprises a translation-equivariant image embedding.

12. The method of claim 11, wherein the first model head and the second model head are parallel neural network decoders, each configured to receive the translation-equivariant image embedding from the model backbone.

13. A method, comprising:
determining an image captured using a sensor onboard an agricultural implement;
using a first set of neural network layers, determining an embedding map for the image;
using a second set of neural network layers, determining a crop instance map directly based on the embedding map, the crop instance map comprising, at each of a first set of pixels, a reference to a crop instance;
using a third set of neural network layers, determining a crop component map directly based on the embedding map, the crop component map comprising, at each of a second set of pixels, a crop component position estimate;
determining a set of crop component positions by aggregating crop component position estimates of the crop component map; and
determining a set of control instructions for the agricultural implement based on the set of crop component positions and the crop instance map.

14. The method of claim 13, wherein a subset of estimates of crop component positions used for aggregation are selected based on correspondence to a crop instance, and wherein a crop component position within the set of crop component positions is determined by aggregating estimates from the subset of estimates.

15. The method of claim 13, wherein the crop component map is determined independently of the crop instance map.

16. The method of claim 13, wherein each crop component position estimate is distinct from a location associated with a respective pixel of the crop component position estimate.

17. The method of claim 13, wherein a crop component position within the set of crop component positions is based on a prior crop component position determined using a prior image of the crop row and a set of motion information for the sensor.

18. The method of claim 13, further comprising determining a set of uncertainty regions for the set of crop component positions, wherein the control instructions cause the agricultural implement to actuate along a path determined using the set of uncertainty regions.

19. The method of claim 13, wherein the crop instance map and the crop component map are determined concurrently.

20. The method of claim 13, further comprising using a fourth set of neural network layers, determining a crop health parameter map based on the embedding map and determining a second set of control instructions based on the crop health parameter map.
